(19) United States
(12) Patent Application Publication
(10) Pub. No.: US 2026/0037673 A1
(43) Pub. Date: Feb. 5, 2026

(54) SYSTEMS AND METHODS FOR DATA MASKING

(71) Applicant: SHANGHAI UNITED IMAGING METAHEALTHCARE CO., LTD., Shanghai (CN)

(72) Inventors: Jian LUO, Wuhan (CN); Yonghui WU, Wuhan (CN); Hao LUO, Wuhan (CN)

(73) Assignee: SHANGHAI UNITED IMAGING METAHEALTHCARE CO., LTD., Shanghai (CN)

(21) Appl. No.: 19/357,082

(22) Filed: Oct. 13, 2025

Related U.S. Application Data
(63) Continuation-in-part of application No. 18/353,043, filed on Jul. 14, 2023, now Pat. No. 12,443,752.
Application No. 18/353,043 is a continuation of application No. PCT/CN2022/072066, filed on Jan. 14, 2022.
(63) Continuation-in-part of application No. 17/819,609, filed on Aug. 12, 2022, now abandoned.

(30) Foreign Application Priority Data
Jan. 14, 2021 (CN) 202110048683.8
Aug. 12, 2021 (CN) 202110923288.X
Dec. 28, 2021 (CN) 202111631678.6

(51) Int. Cl. G06F 21/62

(52) U.S. Cl. CPC G06F 21/6254

(57) ABSTRACT

The present disclosure is related to systems and methods for data masking. The method includes obtaining at least one original file and a hierarchical relationship that is associated with data in the at least one original file. The method includes obtaining a masking template for the data in the at least one original file. The method includes masking the data in the at least one original file based on the masking template, to generate at least one target file. The method includes storing the at least one target file based on the hierarchical relationship.

### CROSS-REFERENCE TO RELATED APPLICATIONS

This application is a continuation in part of U.S. application Ser. No. 18/353,043, filed on Jul. 14, 2023, which is a continuation of International Application No. PCT/CN2022/072066, filed on Jan. 14, 2022, which claims priority of Chinese Patent Application No. 202110048683.8, filed on Jan. 14, 2021, and this application is also a continuation in part of U.S. application Ser. No. 17/819,609, filed on Aug. 12, 2022, which claims priority of Chinese Application No. 202110923288.X, filed on Aug. 12, 2021, and Chinese Application No. 202111631678.6, filed on Dec. 28, 2021, and the contents of which are hereby incorporated by reference.

### TECHNICAL FIELD

This disclosure generally relates to systems and methods for medical information security, and more particularly, relates to systems and methods for data masking in a medical system.

### BACKGROUND

With the development of digitization in the medical field, medical image data is usually communicated and managed via a digital imaging and communications in medicine (DICOM) standard format. Usually, the medical image data (e.g., a DICOM file) includes various types of sensitive and private information of a patient (e.g., a patient name, a patient ID, an address). The medical image data is widely demanded in many fields such as medical teaching, medical communication, and artificial intelligence medical research. The safe dissemination of medical image data relies on the accurate and reasonable masking of the sensitive and private information in the medical image data. Therefore, it is desirable to provide effective systems or methods for data masking in a medical system.

### SUMMARY

According to an aspect of the present disclosure, a method may be implemented on a computing device having one or more processors and one or more storage devices. The method may include obtaining at least one original file and a hierarchical relationship that is associated with data in the at least one original file. The method may include obtaining a masking template for the data in the at least one original file. The method may include masking the data in the at least one original file based on the masking template, to generate at least one target file. The method may include storing the at least one target file based on the hierarchical relationship.

In some embodiments, the method may include obtaining a file search query from a user. The method may include obtaining the at least one original file based on the file search query.

In some embodiments, the method may include obtaining at least one masking mode for the data in the at least one original file. The method may include obtaining at least one masking value corresponding to the at least one masking mode. The method may include obtaining the masking template based on the at least one masking mode and the at least one masking value.

In some embodiments, the data in the at least one original file may include a plurality of tags configured to describe identification information related to the at least one original file. The masking template may include the at least one masking mode for at least one tag of the plurality of tags of the at least one original file. The method may include, for each tag of the at least one tag of the plurality of tags, modifying at least part of a value of the tag based on a masking value corresponding to a corresponding masking mode for the tag. The method may include generating the at least one target file based on at least one modified value of the at least one tag of the plurality of tags.

In some embodiments, the method may include obtaining a tag-based hierarchical relationship of the plurality of tags of the at least one original file.

In some embodiments, the method may include verifying the at least one masking value in the masking template.

In some embodiments, the method may include, for each masking value of the at least one masking value in the masking template, obtaining a data type of a value of a tag. The method may include determining whether the masking value satisfies the data type of the tag. The method may include, in response to determining that the masking value satisfies the data type of the tag, determining that the masking value as a verified masking value.

In some embodiments, the method may include obtaining at least one processed target file by performing a format conversion operation on the at least one target file. The method may include exporting the at least one processed target file.

In some embodiments, the method may include storing the at least one target file in a shared storage space.

In some embodiments, the at least one original file may include a digital imaging and communications in medicine (DICOM) file.

In some embodiments, the masking template may include a plurality of masking modes for the data in the at least one original file. At least two masking modes of the plurality of masking modes may be different.

According to another aspect of the present disclosure, a system may include at least one storage device storing a set of instructions, and at least one processor in communication with the at least one storage device. When executing the stored set of instructions, the at least one processor may cause the system to perform a method. The method may include obtaining at least one original file and a hierarchical relationship that is associated with data in the at least one original file. The method may include obtaining a masking template for the data in the at least one original file. The method may include masking the data in the at least one original file based on the masking template, to generate at least one target file. The method may include storing the at least one target file based on the hierarchical relationship.

According to another aspect of the present disclosure, a non-transitory computer readable medium may include at least one set of instructions. When executed by at least one processor of a computing device, the at least one set of instructions may cause the at least one processor to effectuate a method. The method may include obtaining at least one original file and a hierarchical relationship that is associated with data in the at least one original file. The method may include obtaining a masking template for the data in the at least one original file. The method may include masking the data in the at least one original file based on the masking template, to generate at least one target file. The method may include storing the at least one target file based on the hierarchical relationship.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary medical system according to some embodiments of the present disclosure;

FIG. 2 is a schematic diagram illustrating exemplary hardware and/or software components of an exemplary computing device on which the processing device 120 may be implemented according to some embodiments of the present disclosure;

FIG. 3 is a schematic diagram illustrating exemplary hardware and/or software components of an exemplary mobile device according to some embodiments of the present disclosure;

FIG. 4 is a schematic diagram illustrating an exemplary processing device according to some embodiments of the present disclosure;

FIG. 5 is a flowchart illustrating an exemplary process for storing at least one target file according to some embodiments of the present disclosure;

FIG. 6 is a schematic diagram illustrating an exemplary original file according to some embodiments of the present disclosure;

FIG. 7 is a schematic diagram illustrating an exemplary hierarchical relationship associated with data in an original file according to some embodiments of the present disclosure;

FIG. 8 is a schematic diagram illustrating an exemplary query interface according to some embodiments of the present disclosure;

FIG. 9 is a schematic diagram illustrating an exemplary template setting interface according to some embodiments of the present disclosure;

FIG. 10 is a flowchart illustrating an exemplary process for generating a target document according to some embodiments of the present disclosure; and

FIG. 11 is a schematic diagram illustrating an exemplary target document according to some embodiments of the present disclosure;

FIG. 12 is a schematic diagram illustrating an exemplary file transmission system according to some embodiments of the present disclosure;

FIG. 13A is a schematic diagram illustrating exemplary C-store SCU of a file transmission system according to some embodiments of the present disclosure.

FIG. 13B is a schematic diagram illustrating exemplary C-store SCU of a file transmission system according to some embodiments of the present disclosure.

FIGS. 14A-14D are block diagrams illustrating exemplary processing devices according to some embodiments of the present disclosure;

FIG. 15 is a flowchart illustrating an exemplary process for DICOM file processing according to some embodiments of the present disclosure;

FIG. 16 is a schematic diagram illustrating an exemplary process for DICOM file processing according to some embodiments of the present disclosure;

FIG. 17 is a flowchart illustrating an exemplary process for DICOM file processing according to some embodiments of the present disclosure;

FIG. 18 is a flowchart illustrating an exemplary process for DICOM file processing according to some embodiments of the present disclosure;

FIG. 19 is a flowchart illustrating an exemplary process for DICOM file storage according to some embodiments of the present disclosure;

FIG. 20 is a flowchart illustrating an exemplary process for DICOM file forwarding according to some embodiments of the present disclosure;

FIG. 21 is a schematic diagram illustrating an exemplary process for DICOM file transmission according to some embodiments of the present disclosure;

FIG. 22 is a schematic diagram illustrating an exemplary process for generating a plurality of DICOM sub-files according to some embodiments of the present disclosure;

FIG. 23 is a schematic diagram illustrating an exemplary process for generating a plurality of DICOM sub-files according to some embodiments of the present disclosure;

FIG. 24 is a schematic diagram illustrating an exemplary process for DICOM file storage according to some embodiments of the present disclosure; and

FIG. 25 is a schematic diagram illustrating an exemplary process for generating an initial DICOM file according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Also, the term “exemplary” is intended to refer to an example or illustration.

It will be understood that the terms “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

Spatial and functional relationships between elements are described using various terms, including “connected,” “attached,” and “mounted.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, attached, or positioned to another element, there are no intervening elements present. Other words used to describe the relationship between elements should be interpreted in a like fashion (e.g., “between,” versus “directly between,” “adjacent,” versus “directly adjacent,” etc.).

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

An aspect of the present disclosure relates to a system and method for data masking. As used herein, data masking (also referred to as data anonymization or data pseudonymization, or data de-identification) refers to a process of replacing sensitive identification data using fictitious identification data such as characters or other data. In some embodiments, data masking may include adding text or graphics within an image content (such as handwritten annotations or watermarks), ensuring comprehensive protection of both the image content and the metadata. The purpose of data masking may be to protect sensitive and private information in situations where an enterprise shares data with third parties. According to some embodiments of the present disclosure, a processing device may obtain at least one original file (e.g., a DICOM file) and a hierarchical relationship that is associated with data in the at least one original file. The processing device may obtain a masking template for the data in the at least one original file. The processing device may mask the data in the at least one original file based on the masking template, to generate at least one target file. The processing device may store the at least one target file based on the hierarchical relationship. For example, the processing device may store the at least one target file in a shared storage space. In some embodiments, the processing device may obtain at least one processed target file by performing a format conversion operation on the at least one target file. The processing device may export the at least one processed target file.

Accordingly, the masking template including one or more masking modes for one or more tags of the at least one original file may be flexibly set according to a user preference and/or a masking demand, and the one or more tags in the at least one original file may be masked (e.g., modified) based on the masking template, which may improve the efficiency and flexibility of data masking. In addition, the at least one target file may be stored based on the hierarchical relationship associated with the data of the at least one original file, which may facilitate a user (e.g., a doctor) to retrieve the target file. The hierarchical relationship associated with data of the at least one target file may be unambiguous, thereby avoiding confusion of the data in the at least one target file. Furthermore, the target file of a DICOM format may be converted to a processed target file of another formats (e.g., a bitmap (BMP) format, a joint photographic experts group (JPG) format, a portable network graphics (PNG) format, a tag image file format (TIFF) format), which may facilitate the user to use and/or process the target file. Moreover, the target file and/or the processed target file may be exported to a storage device (e.g., a local disk, a mobile hard disk, a network shared disk) and/or a document (e.g., a Microsoft Office PowerPoint (PPT) document, a Microsoft Office Word document), which may facilitate usage including, e.g., clinical teaching, academic exchange and presentation, and/or image editing. For example, the target file and/or the processed target file may be stored in a shared storage space, which may realize resource sharing, without compromising sensitive information, e.g., identification information, of the subjects represented in the shared images.

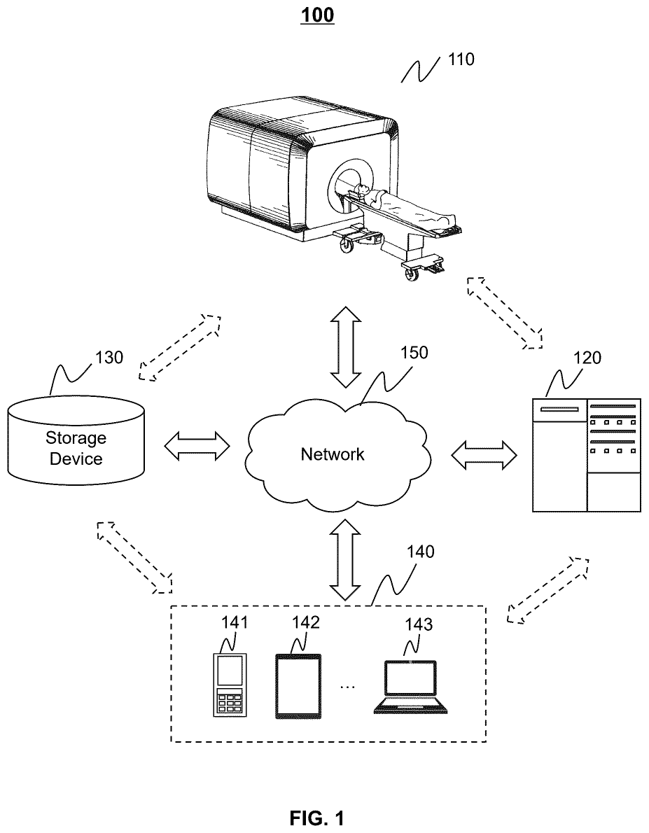

FIG. 1 is a schematic diagram illustrating an exemplary medical system according to some embodiments of the present disclosure. As illustrated, a medical system 100 may include a medical device 110, a processing device 120, a storage device 130, a terminal 140, and a network 150. The components of the medical system 100 may be connected in one or more of various ways. Merely by way of example, as illustrated in FIG. 1, the medical device 110 may be connected to the processing device 120 directly as indicated by the bi-directional arrow in dotted lines linking the medical device 110 and the processing device 120, or through the network 150. As another example, the storage device 130 may be connected to the medical device 110 directly as indicated by the bi-directional arrow in dotted lines linking the medical device 110 and the storage device 130, or through the network 150. As still another example, the terminal 140 may be connected to the processing device 120 directly as indicated by the bi-directional arrow in dotted lines linking the terminal 140 and the processing device 120, or through the network 150.

The medical device 110 may be configured to acquire imaging data relating to a subject. The imaging data relating to a subject may include an image (e.g., an image slice), projection data, or a combination thereof. In some embodiments, the imaging data may be a two-dimensional (2D) imaging data, a three-dimensional (3D) imaging data, a four-dimensional (4D) imaging data, or the like, or any combination thereof. In some embodiments, the imaging data may be communicated and managed via a DICOM standard format.

The subject may be biological or non-biological. For example, the subject may include a patient, a man-made object, etc. As another example, the subject may include a specific portion, an organ, and/or tissue of the patient. Specifically, the subject may include the head, the neck, the thorax, the heart, the stomach, a blood vessel, soft tissue, a tumor, or the like, or any combination thereof. In the present disclosure, “object” and “subject” are used interchangeably.

In some embodiments, the medical device 110 may include a single modality imaging device. For example, the medical device 110 may include a positron emission tomography (PET) device, a single-photon emission computed tomography (SPECT) device, a magnetic resonance imaging (MRI) device (also referred to as an MR device, an MR scanner), a computed tomography (CT) device, an ultrasound (US) device, an X-ray imaging device, or the like, or any combination thereof. In some embodiments, the medical device 110 may include a multi-modality imaging device. Exemplary multi-modality imaging devices may include a PET-CT device, a PET-MRI device, a SPET-CT device, or the like, or any combination thereof. The multi-modality imaging device may perform multi-modality imaging simultaneously. For example, the PET-CT device may generate structural X-ray CT data and functional PET data simultaneously in a single scan. The PET-MRI device may generate MRI data and PET data simultaneously in a single scan.

The processing device 120 may process data and/or information obtained from the medical device 110, the storage device 130, and/or the terminal(s) 140. For example, the processing device 120 may obtain at least one original file and a hierarchical relationship that is associated with data in the at least one original file. As another example, the processing device 120 may obtain a masking template for data in at least one original file. As another example, the processing device 120 may mask data in at least one original file based on the masking template, to generate at least one target file. As another example, the processing device 120 may store at least one target file based on a hierarchical relationship associated with data in at least one original file. In some embodiments, the processing device 120 may be a single server or a server group. The server group may be centralized or distributed. In some embodiments, the processing device 120 may be local or remote. For example, the processing device 120 may access information and/or data from the medical device 110, the storage device 130, and/or the terminal(s) 140 via the network 150. As another example, the processing device 120 may be directly connected to the medical device 110, the terminal(s) 140, and/or the storage device 130 to access information and/or data. In some embodiments, the processing device 120 may be implemented on a cloud platform. For example, the cloud platform may include a private cloud, a public cloud, a hybrid cloud, a community cloud, a distributed cloud, an inter-cloud, a multi-cloud, or the like, or a combination thereof. In some embodiments, the processing device 120 may be part of the terminal 140. In some embodiments, the processing device 120 may be part of the medical device 110.

The storage device 130 may store data, instructions, and/or any other information. In some embodiments, the storage device 130 may store data obtained from the medical device 110, the processing device 120, and/or the terminal(s) 140. The data may include image data acquired by the processing device 120, algorithms and/or models for processing the image data, etc. For example, the storage device 130 may store at least one original file and a hierarchical relationship that is associated with data in the at least one original file. As another example, the storage device 130 may store a masking template for data in at least one original file. As another example, the storage device 130 may store at least one target file generated by the processing device 120. In some embodiments, the storage device 130 may store data and/or instructions that the processing device 120 and/or the terminal 140 may execute or use to perform exemplary methods described in the present disclosure. In some embodiments, the storage device 130 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memories may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), a high-speed RAM, etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more other components in the medical system 100 (e.g., the processing device 120, the terminal(s) 140). One or more components in the medical system 100 may access the data or instructions stored in the storage device 130 via the network 150. In some embodiments, the storage device 130 may be integrated into the medical device 110.

The terminal(s) 140 may be connected to and/or communicate with the medical device 110, the processing device 120, and/or the storage device 130. In some embodiments, the terminal 140 may include a mobile device 141, a tablet computer 142, a laptop computer 143, or the like, or any combination thereof. For example, the mobile device 141 may include a mobile phone, a personal digital assistant (PDA), a gaming device, a navigation device, a point of sale (POS) device, a laptop, a tablet computer, a desktop, or the like, or any combination thereof. In some embodiments, the terminal 140 may include an input device, an output device, etc. The input device may include alphanumeric and other keys that may be input via a keyboard, a touchscreen (for example, with haptics or tactile feedback), a speech input, an eye tracking input, a brain monitoring system, or any other comparable input mechanism. Other types of the input device may include a cursor control device, such as a mouse, a trackball, or cursor direction keys, etc. The output device may include a display, a printer, or the like, or any combination thereof.

The network 150 may include any suitable network that can facilitate the exchange of information and/or data for the medical system 100. In some embodiments, one or more components of the medical system 100 (e.g., the medical device 110, the processing device 120, the storage device 130, the terminal(s) 140, etc.) may communicate information and/or data with one or more other components of the medical system 100 via the network 150. For example, the processing device 120 and/or the terminal 140 may obtain at least one original file (e.g., a DICOM file) from the medical device 110 via the network 150. As another example, the processing device 120 and/or the terminal 140 may obtain information stored in the storage device 130 via the network 150. The network 150 may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (VPN), a satellite network, a telephone network, routers, hubs, witches, server computers, and/or any combination thereof. For example, the network 150 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 150 may include one or more network access points. For example, the network 150 may include wired and/or wireless network access points such as base stations and/or internet exchange points through which one or more components of the medical system 100 may be connected to the network 150 to exchange data and/or information.

This description is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. However, those variations and modifications do not depart the scope of the present disclosure. In some embodiments, the medical system 100 may include a picture archiving and communication systems (PACS). In some embodiments, the processing device 120 may be part of the PACS. For example, the PACS may store one or more original files (e.g., one or more DICOM files) acquired by a medical device (e.g., the medical device 110). In some embodiments, the PACS may obtain the one or more original files from the medical device (e.g., the medical device 110) directly. In some embodiments, the medical device (e.g., the medical device 110) may transmit the one or more original files to a storage device (e.g., a local disk, a network disk) of the medical system 100. The PACS may obtain the one or more original files from the storage device. The PACS may obtain a hierarchical relationship associated with data in the one or more original files. The PACS may obtain a masking template for the data in the one or more original files. The PACS may mask the data in the one or more original files based on the masking template, to generate one or more target files. The PACS may store the one or more target files based on the hierarchical relationship associated with the data in the one or more original files.

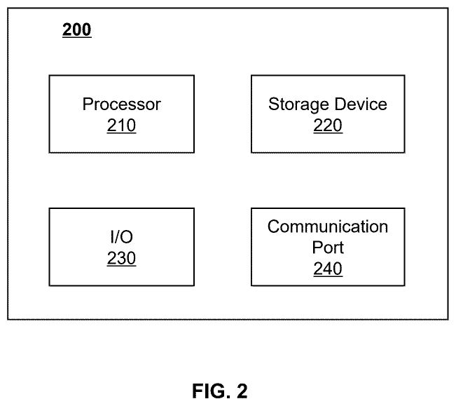

FIG. 2 is a schematic diagram illustrating exemplary hardware and/or software components of an exemplary computing device on which the processing device 120 may be implemented according to some embodiments of the present disclosure. As illustrated in FIG. 2, a computing device 200 may include a processor 210, a storage device 220, an input/output (I/O) 230, and a communication port 240.

The processor 210 may execute computer instructions (e.g., program code) and perform functions of the processing device 120 in accordance with techniques described herein. The computer instructions may include, for example, routines, programs, objects, components, data structures, procedures, modules, and functions, which perform particular functions described herein. For example, the processor 210 may process image data obtained from the medical device 110, the terminal 140, the storage device 130, and/or any other component of the medical system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combination thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both process A and process B, it should be understood that process A and process B may also be performed by two or more different processors jointly or separately in the computing device 200 (e.g., a first processor executes process A and a second processor executes process B, or the first and second processors jointly execute processes A and B).

The storage device 220 may store data/information obtained from the medical device 110, the terminal 140, the storage device 130, and/or any other component of the medical system 100. The storage device 220 may be similar to the storage device 130 described in connection with FIG. 1, and the detailed descriptions are not repeated here.

The I/O 230 may input and/or output signals, data, information, etc. In some embodiments, the I/O 230 may enable a user interaction with the processing device 120. In some embodiments, the I/O 230 may include an input device and an output device. Examples of the input device may include a keyboard, a mouse, a touchscreen, a microphone, a sound recording device, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touchscreen, or the like, or a combination thereof.

The communication port 240 may be connected to a network (e.g., the network 150) to facilitate data communications. The communication port 240 may establish connections between the processing device 120 and the medical device 110, the terminal 140, and/or the storage device 130. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G), or the like, or any combination thereof. In some embodiments, the communication port 240 may be and/or include a standardized communication port, such as RS232, RS485. In some embodiments, the communication port 240 may be a specially designed communication port. For example, the communication port 240 may be designed in accordance with the digital imaging and communications in medicine (DICOM) protocol.

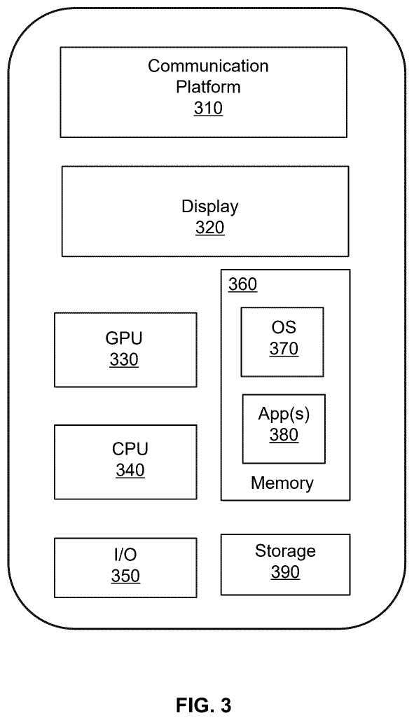

FIG. 3 is a schematic diagram illustrating exemplary hardware and/or software components of an exemplary mobile device according to some embodiments of the present disclosure. In some embodiments, the terminal 140 and/or the processing device 120 may be implemented on a mobile device 300, respectively.

As illustrated in FIG. 3, the mobile device 300 may include a communication platform 310, a display 320, a graphics processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300.

In some embodiments, the communication platform 310 may be configured to establish a connection between the mobile device 300 and other components of the medical system 100, and enable data and/or signal to be transmitted between the mobile device 300 and other components of the medical system 100. For example, the communication platform 310 may establish a wireless connection between the mobile device 300 and the medical device 110, and/or the processing device 120. The wireless connection may include, for example, a Bluetooth™ link, a Wi-Fi™ link, a WiMax™ link, a WLAN link, a ZigBee link, a mobile network link (e.g., 3G, 4G, 5G), or the like, or any combination thereof. The communication platform 310 may also enable the data and/or signal between the mobile device 300 and other components of the medical system 100. For example, the communication platform 310 may transmit data and/or signals inputted by a user to other components of the medical system 100. The inputted data and/or signals may include a user instruction. As another example, the communication platform 310 may receive data and/or signals transmitted from the processing device 120. The received data and/or signals may include imaging data acquired by the medical device 110.

In some embodiments, a mobile operating system (OS) 370 (e.g., iOS™, Android™, Windows Phone™, etc.) and one or more applications (App(s)) 380 may be loaded into the memory 360 from the storage 390 in order to be executed by the CPU 340. The applications 380 may include a browser or any other suitable mobile apps for receiving and rendering information from the processing device 120. User interactions with the information stream may be achieved via the I/O 350 and provided to the processing device 120 and/or other components of the medical system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result the drawings should be self-explanatory.

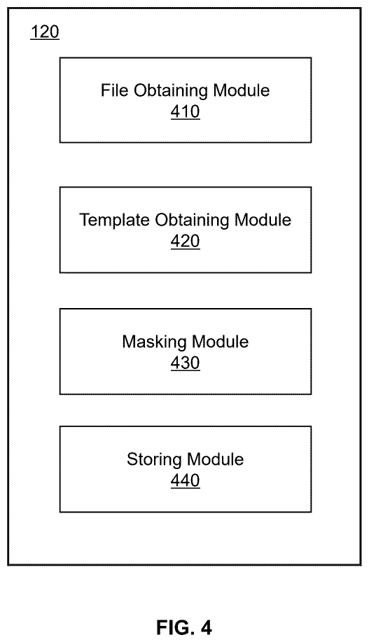

FIG. 4 is a schematic diagram illustrating an exemplary processing device according to some embodiments of the present disclosure. In some embodiments, the processing device 120 may include a file obtaining module 410, a template obtaining module 420, a masking module 430, and a storing module 440.

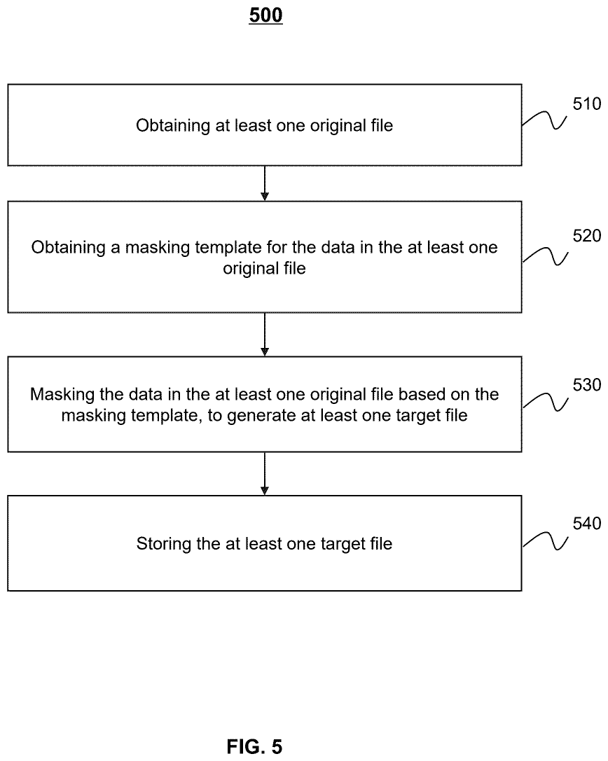

The file obtaining module 410 may be configured to obtain at least one original file and a hierarchical relationship associated with data in the at least one original file. In some embodiments, the file obtaining module 410 may obtain a file search query from a user. The file obtaining module 410 may obtain at least one original file based on the file search query. In some embodiments, the file obtaining module 410 may obtain a hierarchical relationship associated with data in at least one original file based on at least one tag in the at least one original file. More descriptions for obtaining the at least one original file and the hierarchical relationship associated with the data in the at least one original file may be found elsewhere in the present disclosure (e.g., operation 510 in FIG. 5 and descriptions thereof).

The template obtaining module 420 may be configured to obtain a masking template for data in at least one original file. In some embodiments, the template obtaining module 420 may obtain at least one masking mode for data in at least one original file. The template obtaining module 420 may obtain at least one masking value corresponding to the at least one masking mode. The template obtaining module 420 may obtain the masking template based on the at least one masking mode and the at least one masking value. More descriptions for obtaining a masking template may be found elsewhere in the present disclosure (e.g., operation 520 in FIG. 5 and descriptions thereof).

The masking module 430 may be configured to mask data in at least one original file based on a masking template, to generate at least one target file. In some embodiments, for each tag of a plurality of tags in at least one original file, the masking module 430 may mask (e.g., modify) at least part of a value of the tag based on a masking value corresponding to a corresponding masking mode for the tag in the masking template. In some embodiments, the value of the tag may include a plurality of characters (e.g., a mark, a sign, a symbol, a letter, a Chinese character). The masking module 430 may mask (e.g., modify) one or more characters of the plurality of characters of the value of the tag based on the masking value corresponding to the masking mode for the tag. For example, the masking module 430 may replace one or more characters of the plurality of characters of the value of the tag with the masking value corresponding to the masking mode for the tag. The masking module 430 may generate at least one target file based on at least one masked value (e.g., modified value) of the at least one tag of the plurality of tags. More descriptions for generating the at least one target file may be found elsewhere in the present disclosure (e.g., operation 530 in FIG. 5 and descriptions thereof).

The storing module 440 may be configured to store at least one target file. In some embodiments, the storing module 440 may store at least one target file based on a hierarchical relationship associated with data in at least one original file. In some embodiments, a hierarchical relationship associated with data in at least one target file may be the same as a hierarchical relationship associated with data in at least one original file. More descriptions for storing the at least one target file may be found elsewhere in the present disclosure (e.g., operation 540 in FIG. 5 and descriptions thereof).

It should be noted that the above description of the processing device 120 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more modules may be combined into a single module. For example, the file obtaining module 410 and the template obtaining module 420 may be combined into a single module. In some embodiments, one or more modules may be added or omitted in the processing device 120. For example, the processing device 120 may further include a storage module (not shown in FIG. 4) configured to store data and/or information (e.g., at least one original file, a hierarchical relationship associated with data in at least one original file, a masking template, at least one target file) associated with the medical system 100. As another example, the processing device 120 may further include a verifying module (not shown in FIG. 4) configured to verify at least one masking value in a masking template.

FIG. 5 is a flowchart illustrating an exemplary process for storing at least one target file according to some embodiments of the present disclosure. In some embodiments, process 500 may be executed by the medical system 100. For example, the process 500 may be implemented as a set of instructions (e.g., an application) stored in a storage device (e.g., the storage device 130, the storage device 220, and/or the storage 390). In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 500. The operations of the illustrated process presented below are intended to be illustrative. In some embodiments, the process 500 may be accomplished with one or more additional operations not described and/or without one or more of the operations discussed. Additionally, the order of the operations of process 500 illustrated in FIG. 5 and described below is not intended to be limiting.

In 510, the processing device 120 (e.g., the file obtaining module 410) may obtain at least one original file.

In some embodiments, the medical system 100 may include a picture archiving and communication system (PACS). The PACS may use digital imaging and communications in medicine (DICOM) to store and transmit images. In some embodiments, the PACS may store one or more original files. In some embodiments, the original file may include a DICOM file. The DICOM file may include an image (e.g., a CT image, an MRI image, a PET image) in the DICOM format. As used herein, a DICOM may refer to a standard for image data storage and transfer. The DICOM may use a specific file format and a communication protocol to define a medical image format that can be used for data exchange that meets clinical needs in terms of image quality.

In some embodiments, the original file (e.g., the DICOM file) may be obtained from a medical device (e.g., the medical device 110) directly. In some embodiments, the original file (e.g., the DICOM file) may be obtained by performing a format conversion operation on a file with a non-DICOM format. For example, the non-DICOM format may include an MRI scan format of a specific manufacturer, a grid data format, a neuroimaging informatics technology initiative format, or the like.

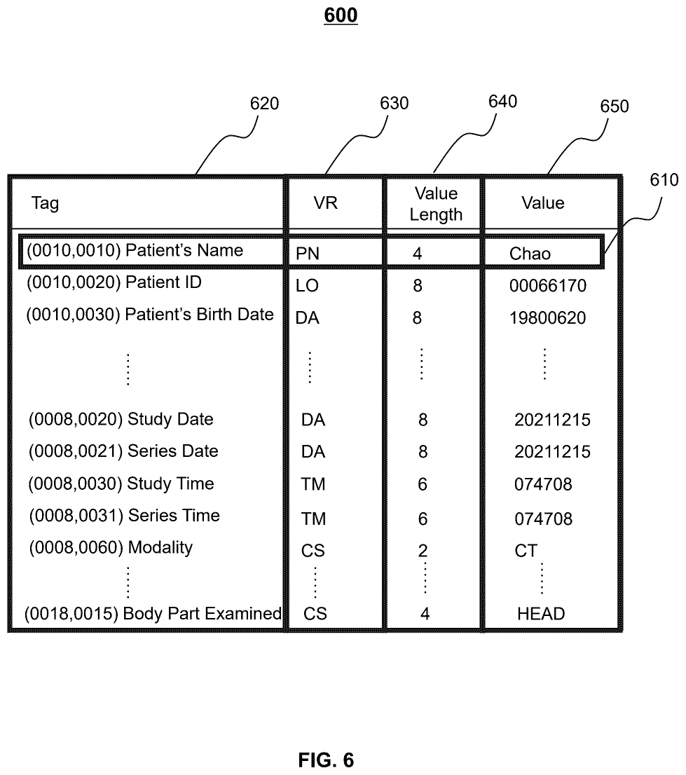

In some embodiments, the data in the original file may include a plurality of data elements (e.g., a data element 610 as illustrated in FIG. 6). The plurality of data elements may be configured to describe identification information related to the original file. Each data element may describe one or more types of identification information related to the original file. The identification information related to the original file may include information related to a patient (e.g., an identification (ID) number, a name, the gender, the age, a date of birth, a scan region), information related to an operation (e.g., a scan) of the patient (e.g., a scanning parameter), information related to a medical device that performs the operation on the patient (e.g., a modality of the medical device, a model of the medical device), information related to an image of the patient (e.g., a size, a density resolution, a spatial resolution, a signal-to-noise ratio, an image reconstruction parameter), or the like, or any combination thereof.

In some embodiments, each data element of the plurality of data elements of the original file may include a tag, a data type (also referred to as a value representation (VR)) of the tag, a value length of the tag, a value of the tag, or the like, or any combination thereof. FIG. 6 is a schematic diagram illustrating an exemplary original file according to some embodiments of the present disclosure. As illustrated in FIG. 6, identification information related to an original file 600 (e.g., a DICOM file) may include a plurality of data elements 610. A row of data in the original file 600 may be one data element 610. Each data element 610 may include a tag 620, a VR 630 of the tag 620, a value length 640 of the tag 620, a value 650 of the tag 620.

The tag may describe a type of identification information related to the original file. In some embodiments, the tag may be in a form of a collection of numbers. For example, the tag may include codes consisting of two hexadecimal components (e.g., a group number, an element number). Merely by way of example, as illustrated in FIG. 6, the patient ID may have a tag of (0010, 0020), wherein “0010” is a group number, and “0020” is an element number. The data type may describe the format of the value of the tag. In some embodiments, the data type may be represented as two-character code. For example, the data type may include PN (person name), CS (code string), SH (short string), LO (long string), UI (unique identifier), DA (date), TM (time), or the like, or any combination thereof, as described elsewhere in the present disclosure (e.g., Table 1 and descriptions thereof). The value length may describe a character count of the value of the tag. For example, if a value of a tag of patient ID is “00066170,” the value length of the tag of patient ID is eight. In some embodiments, the identification information corresponding to the tag may include sensitive information, privacy information, or the like, of a patient.

In some embodiments, the data (e.g., the plurality of tags, the VRs of the plurality of tags, the value lengths of the plurality of tags, the values of the plurality of tags) in the original file may be organized into multiple levels of hierarchy to form a hierarchical relationship that is associated with data in the at least one original file. In some embodiments, the hierarchical relationship associated with the data in the plurality of original files may represent a relationship between the data in the plurality of original files. The relationship between the data in the plurality of original files may include a relationship between tags of the plurality of original files. In some embodiments, the hierarchical relationship may also be associated with a relationship of the plurality of tags in the original file. The original file may include a medical file, a DICOM file, or the like. In some embodiments, the plurality of tags in the original file may have a tag-based hierarchical relationship. The tag-based hierarchical relationship may be a multiple-level hierarchy. For example, the plurality of tags may have a four-level hierarchy. The four-level hierarchy may include a patient level, a study level, a series level, and an image level. In some embodiments, each level may correspond to an UID. For example, the patient level may correspond to a patient ID. The study level may correspond to a study instance UID. The series level may correspond to a series instance UID. The image level may correspond to a SOP instance UID. In some embodiments, the study instance UID, the series instance UID and the SOP instance UID may be globally unique identifiers. The tags of the patient level may include information related to a patient (e.g., a patient ID, a name, the gender, the age, a date of birth, a scan region). The tags of the study level may include information related to a study (e.g., an imaging procedure) of a patient (e.g., a study instance unique identifier (UID), a study date, a study time). The tags of the series level may include information related to a series of a study of a patient (e.g., a series instance UID, a series date, a series time, a modality of a medical device that acquires scan data used to generated an image in the series). In some embodiments, the series of the patient may be defined by a medical device acquiring image(s) in the series, one or more scanning parameters used by the medical device scanning the patient, an image reconstruction technique for image(s) in the series, or the like, or any combination thereof. Different images of a same subject acquired by different medical devices may correspond to different series. For example, an MR image of a patient obtained by an MRI device may be considered a different series than a PET image of the patient obtained by a PET device. Different images of a same subject generated using different image reconstruction techniques based on same scan data (e.g., projection data) may correspond to different series. For example, an image generated using an image reconstruction technique (e.g., a back-projection technique) based on scan data (e.g., projection data) may be considered a different series than another image generated using another image reconstruction technique (e.g., an iteration reconstruction technique) based on the same scan data (e.g., projection data). Different images generated using a same imaging device but based on different scanning parameters may correspond to different series. For example, an MR image generated based on k-space data acquired by an MRI device according to a spin-echo sequence may be considered a different series than another MR image generated based on k-space data acquired by the same MRI device according to a gradient echo sequence. The tags of the image level may include information related to an image of the patient (e.g., a service-object pair (SOP) instance UID, an image type, an acquisition date, an acquisition time, a size, a density resolution, a spatial resolution, a signal-to-noise ratio, an image reconstruction parameter).

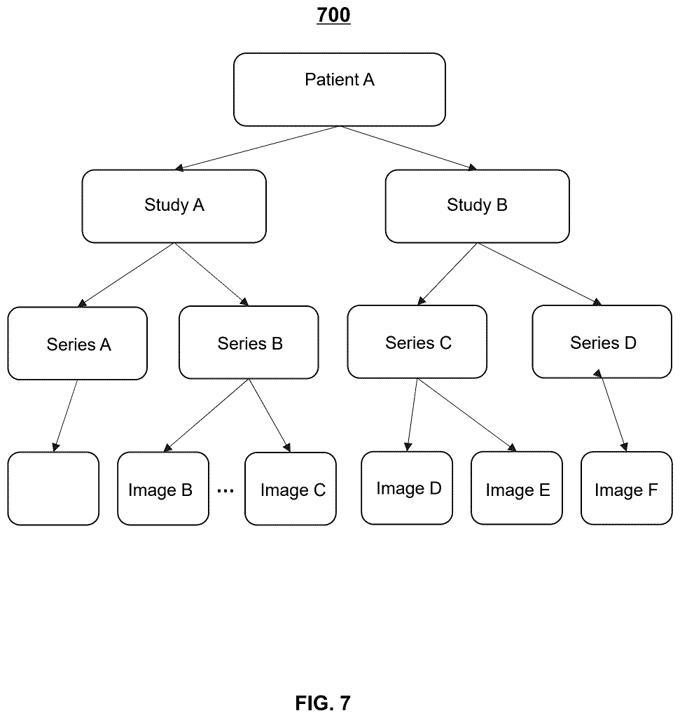

In some embodiments, a patient may correspond to one or more studies. Each study may correspond to one or more series. Each series may correspond to one or more images. FIG. 7 is a schematic diagram illustrating an exemplary hierarchical relationship associated with data in an original file according to some embodiments of the present disclosure. As illustrated in FIG. 7, a patient A may correspond to a study A and a study B. For example, two imaging procedures (e.g., the study A and the study B) may be performed on the patient A. The study A may include a series A and a series B. The study B may include a series C and a series D. For example, in the study A (or the study B), a CT scan and an MRI scan may be performed on the patient A. The series A (or the series C) may include data related to the CT scan. The series B (or the series D) may include data related to the MRI scan. The series A may include an image A (e.g., a CT image). The series B may include an image B (e.g., an MRI image) and an image C (e.g., an MRI image). The series C may include an image D (e.g., a CT image) and an image E (e.g., a CT image). The series D may include an image F (e.g., an MRI image). In some embodiments, different images in a same series may correspond to different image quality parameters (e.g., a density resolution, a spatial resolution, a signal-to-noise ratio). In some embodiments, different images in a same series may correspond to different portions of the scan region of the patient A.

In some embodiments, a plurality of original files may be stored in a database (e.g., the PACS) of the medical system 100 based on the hierarchical relationship associated with the data in the plurality of original files. For example, the database may include a plurality of first-level directories. Each first-level directory may correspond to a patient. That is, one or more original files (e.g., DICOM files) associated with a specific patient may be stored in a corresponding first-level directory. Each first-level directory may include one or more second-level directories. Each second-level directory may correspond to a study of a patient. That is, one or more original files (of the plurality of original files) associated with a specific study of the patient may be stored in a corresponding second-level directory of the first-level directory. Each second-level directory may include one or more third-level directories. Each third-level directory may correspond to a series of a study of a patient. That is, one or more original files (of the plurality of original files) associated with a specific series of the study of the patient may be stored in a corresponding third-level directory of the second-level directory of the first-level directory. For example, referring to FIG. 7, a database may include a first-level directory corresponding to the patient A. The first-level directory may include a second-level directory A corresponding to the study A, and a second-level directory B corresponding to the study B. The second-level directory A may include a third-level directory A corresponding to the series A, and a third-level directory B corresponding to the series B. The second-level directory B may include a third-level directory C corresponding to the series C, and a third-level directory D corresponding to the series D. The image A may be stored in the third-level directory A. The image B and the image C may be stored in the third-level directory B. The image D and the image E may be stored in the third-level directory C. The image D may be stored in the third-level directory D.

In some embodiments, the processing device 120 may obtain the at least one original file from a storage device (e.g., the storage device 130) of the medical system 100 or an external database (e.g., a storage device implemented on a cloud platform) via the network 150 directly. In some embodiments, the processing device 120 may obtain a file search query from a user. In some embodiments, the file search query may include a request for a data masking operation. In some embodiments, the file search query may trigger a data masking operation. For example, the file search query may include one or more keywords associated with the information related to a patient, the information related to a study of the patient, the information related to a series of the study of the patient, the information related to an image of the patient, or the like, or any combination thereof. The file search query may be in any form. For example, the file search query may be in the form of text, voice, a picture, or the like, or any combination thereof. Further, the processing device 120 may obtain the at least one original file based on the file search query. For example, the processing device 120 may obtain data to be masked (e.g., one or more tags to be masked) in the at least one original file and/or storage information of the data to be masked in the at least one original file based on the file search query. The storage information of the data to be masked in the at least one original file may include a storage path of the at least one original file, a storage date of the at least one original file, or the like, or any combination thereof. As used herein, a storage path of a file refers to a storage location of the file in a database. As used herein, a storage date of a file refers to a date when the file is stored in a database. The processing device 120 may obtain the at least one original file based on the data to be masked in the at least one original file and/or the storage information of the data to be masked in the at least one original file. Accordingly, the at least one original file may be automatically obtained based on the file search query including one or more keywords, and the user does not need to manually search the at least one original file (e.g., the user manually opens a folder to find the at least one original file), which may save query time and improve query efficiency.

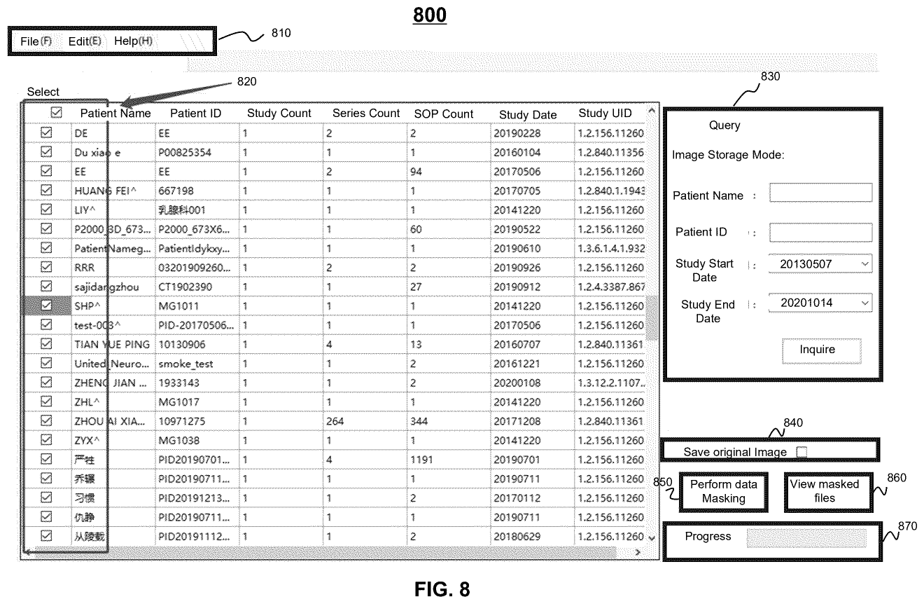

In some embodiments, the user may input the query request via a data masking system (e.g., a PACS image archiving system). For example, a terminal device (e.g., the terminal 140) of the user may display a query interface of the data masking system configured to obtain the file search query from the user. FIG. 8 is a schematic diagram illustrating an exemplary query interface according to some embodiments of the present disclosure. As illustrated in FIG. 8, a query interface 800 may include one or more user interface elements for presenting information associated with a data masking system. The user interface elements may include one or more buttons, icons, checkboxes, message boxes, text fields, data fields, search fields, or the like. For example, the query interface 800 may include a menu bar 810 for presenting operations (e.g., “file,” “edit,” “help”) associated with the data masking system. The query interface 800 may also include a data section 820 for presenting data (e.g., a plurality of original files, a plurality of tags of a plurality of original files) that can be selected by the user to initiate a file search query. The user can initiate a file search query by selecting one or more tags via the data section 820.

The query interface 800 may further include a search box 830 for presenting a file search query inputted by a user. The user can input one or more keywords in the search box 830 to initiate a file search query. In some embodiments, after the user inputs one or more keywords in the search box 830 to initiate a file search query, the data section 820 may present a search result. The search result may include data (e.g., one or more original files, one or more tags of one or more original files) associated with the file search query. The user may modify the presented data (e.g., the one or more original files, the one or more tags of one or more original files) associated with the file search query. For example, the user may add one or more original files in the data section 820 and/or remove one or more original files presented in the data section 820 by clicking one or more boxes corresponding to the one or more original files. The query interface 800 may further include an option section 840 that can be selected by the user to determine whether the original file needs to be saved. The query interface 800 may further include a button 850 that can be selected by the user to perform a data masking operation. The query interface 800 may further include a button 860 that can be selected by the user to view a masked file (i.e., a target file). The query interface 800 may further include a progress bar 870 for presenting a progress of data masking.

For illustration purposes, as illustrated in FIG. 8, if a file search query is that the study start date is 20130507 and the study end date is 20201014, the data section 820 may present a search result. The search result may include data (e.g., a plurality of original files) associated with a plurality of patients whose study dates are between the study start date (i.e., 20130507) and the study end date (i.e., 20201014). The user may add data associated with one or more other patients in the data section 820. The user may also delete the data associated with the one or more patients presented in the data section 820.

In some embodiments, after the user confirms the search result, one or more selected patients in the data section 820 may be marked. The processing device 120 may obtain study instance UIDs of the one or more marked patients. The processing device 120 may obtain SOP instance UIDs of one or more original files corresponding to the study instance UIDs of the one or more marked patients. The processing device 120 may obtain storage paths of the one or more original files based on the SOP instance UIDs of one or more original files. The processing device 120 may obtain data (e.g., one or more tags) in the one or more original files based on the storage paths of the one or more original files. For example, the processing device 120 may downloaded the one or more original files from a cloud environment, and store the one or more original files in a temporary directory or temporary folder on a local storage device. In some embodiments, the user may manually select the at least one original file stored in a local folder. The processing device 120 may further mask the data (e.g., the one or more tags) in the one or more original file based on a masking template as described elsewhere in the present disclosure.

In some embodiments, the processing device 120 may obtain the hierarchical relationship associated with the data in the at least one original file based on the at least one tag in the at least one original file. For example, after a tag of patient name is selected in the data section 820 of the query interface 800, the processing device 120 may obtain a study instance UID of the patient. The processing device 120 may obtain one or more series corresponding to the study instance UID of the patient. The processing device 120 may obtain one or more images corresponding to each series of the one or more series corresponding to the study instance UID of the patient. The processing device 120 may obtain the hierarchical relationship based on the one or more series corresponding to the study instance UID of the patient, and the one or more images corresponding to each series of the one or more series corresponding to the study instance UID of the patient. In some embodiments, the hierarchical relationship associated with the data in the at least one original file may be stored in a storage device (e.g., a memory) of the medical system 100 or an external database in a form of computer codes.

In 520, the processing device 120 (e.g., the template obtaining module 420) may obtain a masking template for the data in the at least one original file. As used in the present disclosure, the masking template is also referred to as a masking rule, a modification rule, a modification reference, or a modification template.

In some embodiments, the processing device 120 may obtain at least one masking mode for the data in the at least one original file. The processing device 120 may obtain at least one masking value corresponding to the at least one masking mode. The masking value corresponding to a masking mode for a tag may be used to replace at least part of a value of the tag. The masking value may include any symbols and/or characters. For example, the masking value may include a letter, a number, a punctuation, a pattern, or the like, or any combination thereof. The masking value may be a default value, a random value, or the like. The processing device 120 may obtain the masking template based on the at least one masking mode and the at least one masking value. In some embodiments, the masking template may include at least one masking mode for at least one tag of a plurality of tags of the at least one original file. For example, a masking mode for a tag may include replacing at least part of a value of the tag with one or more masking values.

In some embodiments, the masking template may include one or more tags of the at least one original file, one or more masking modes corresponding to the one or more tags, and one or more masking values corresponding to the one or more masking modes. Each masking mode of the one or more masking modes may correspond to a tag of the one or more tags of the at least one original file. The masking modes of different tags may be the same or different. The masking values corresponding to different masking modes may be the same or different.

In some embodiments, the masking template may be previously determined by a user of the medical system 100, or one or more components (e.g., the processing device 120) of the medical system 100 according to different situations. In some embodiments, the processing device 120 may obtain a template setting request from a user. The template setting request may be a request for setting a masking template. The processing device 120 may cause a terminal device to display a template setting interface. The user may determine one or more masking parameters of the masking template via the template setting interface. The masking parameter may include a masking mode, a masking value, a masking type, a masking period, or the like, or any combination thereof.

In some embodiments, after the processing device 120 obtains the template setting request from the user, the processing device 120 may cause the terminal device to display a plurality of tags of the at least one original file. The processing device 120 may obtain a tag editing request from the user. The tag editing request may include deleting a tag from the plurality of tags, adding a tag in the plurality of tags, or the like, or any combination thereof. For example, the user may input the tag editing request via a delete tag button (e.g., a delete tag button as illustrated in FIG. 9) and/or an insert tag button (e.g., an insert tag button as illustrated in FIG. 9) in the template setting interface. As another example, the user may input the tag editing request via a voice. After one or more tags are selected from the plurality of tags of the at least one original file, one or more masking modes for the one or more selected tags, and one or more masking values corresponding to the one or more masking modes may be determined. The masking template for the at least one original file may be generated based on the one or more selected tags, one or more masking modes for the one or more sleeted tags, and one or more masking values corresponding to the one or more masking modes. In some embodiments, the masking template may be stored in the format of an extensible markup language (XML) file.

FIG. 9 is a schematic diagram illustrating an exemplary template setting interface according to some embodiments of the present disclosure. As illustrated in FIG. 9, a template setting interface 900 may include one or more user interface elements for presenting information associated with a masking template. For example, the template setting interface 900 may include a tag section 910 for presenting one or more tags (e.g., “all tags,” “tags of a patient level,” “tags of a study level,” “tags of a series level,” “tags of an image level”) that can be selected by the user to edit one or more masking modes for the one or more tags. A tag 920 may include a group number and an element number. The tag 920 may correspond to a VR 930 and a tag description 940. The template setting interface 900 may also include an anonytype editing section 950 (also referred to as a masking mode editing section) for presenting a masking mode for a tag. The user may input or select a masking mode for a tag via the anonytype editing section 950. The template setting interface 900 may further include a masking value editing section 960 for presenting a masking value corresponding to a masking mode. The user may input or select a masking value corresponding to a masking mode for a tag via the masking value editing section 960. For example, the user may select a specific tag in the tag section 910. The user may input a masking mode for the specific tag via the anonytype editing section 950. The user may input a masking value corresponding to the masking mode for the specific tag via the masking value editing section 960.

The template setting interface 900 may further include a value option section 970 that can be selected by the user to delete a masking value. The template setting interface 900 may further include a tag editing section 980 that can be selected by the user to delete or insert a tag. The tag editing section 980 may include a delete tag button and an insert tag button. The delete tag button may be used for deleting a tag in the masking template. The insert tag button may be used for adding a tag in the masking template. For example, the user may delete (or insert) a tag by clicking the delete tag button (or the insert tag button) in the tag editing section 980 via a mouse. The template setting interface 900 may further include a button 990 that can be selected by the user to confirm the setting of the masking template. The template setting interface 900 may further include a button 995 that can be selected by the user to cancel the setting of the masking template.

Traditionally, one or more tags of at least one original file may be masked based on a same masking mode, which may lead to low efficiency and low flexibility of data masking. According to some embodiments of the present disclosure, the masking template including one or more masking modes for one or more tags of the at least one original file may be flexibly set according to a user preference and/or a masking demand, and the one or more tags in the at least one original file may be masked based on the masking template, which may improve the efficiency and flexibility of data masking. In some embodiments, the masking template may include a plurality of different masking modes for a plurality of tags of the at least one original file, and values of the plurality of tags may be masked using the masking template at the same time, which may improve the efficiency and flexibility of data masking.

In some embodiments, the processing device 120 may verify the at least one masking value in the masking template. In some embodiments, the format of the masking value corresponding to the masking mode for the tag may need to satisfy the data type of the tag. The format of the masking value may include a character type (e.g., a letter, a number, a punctuation, a pattern) of a character in the masking value, a character count in the masking value, or the like. Table 1 shows exemplary value representations (also referred to as data types) of a tag. As shown in Table 1, a VR may correspond to a character repertoire and a length of value. The character repertoire and the length of value corresponding to the VR may define the format of the masking value corresponding to the masking mode for the tag corresponding to the VR. For example, if a data type of a tag of patient ID is LO, character count of a masking value corresponding to a masking mode for the tag of patient ID cannot be greater than 64. As another example, if a data type of a tag of study date is DA, character counts of a masking value corresponding to a masking mode for the tag of study date can only be 8, and the characters of the masking value corresponding to the masking mode for the tag of study date can only contain numbers (e.g., 0˜9).

TABLE 1
Exemplary value representations (VRs) of a tag

| | | Character | Length of |
|---|---|---|---|
| VR | Definition | Repertoire | Value |
| PN | Patient name with caret | — | 64 |
| (Person | “\hat{ }” as the separator, | | characters |
| Name) | such as “SMITH\hat{ }JOHN.” | | maximum |
| CS (Code | String of characters with | Uppercase | 16 |
| String) | leading or trailing | characters, | characters |
| | spaces being non- | “0”-“9”, the | maximum |
| | significant. | SPACE | |
| | | character, | |
| | | and | |
| | | underscore | |
| | | “_” | |
| SH (Short | A short string, such as: | — | 16 |
| String) | phone number, ID, etc. | | characters |
| | | | maximum |
| LO (Long | A character string that | — | 64 |
| String) | may be padded with | | characters |
| | leading and/or trailing | | maximum |
| | spaces. | | |
| UI (Unique | A character string | “0”-“9” and | 64 |
| Identifier, | containing a UID that is | “.” | characters |
| UID) | used to uniquely identify | | maximum |
| | a wide variety of items, | | |
| | such as “1.2.840.1008.1.1.” | | |
| DA (Date) | A string of characters of | “0”-“9” | 8 |
| | the format YYYYMMDD; | | characters |
| | where YYYY shall | | fixed |
| | contain year, MM shall | | |
| | contain the month, and | | |
| | DD shall contain the | | |
| | day, such as “2050822.” | | |

In some embodiments, for each masking value of the at least one masking value corresponding to the at least one masking mode in the masking template, the processing device 120 may obtain a data type of a tag. The processing device 120 may determine whether the masking value satisfies the data type of the tag. In response to determining that the masking value satisfies the data type of the tag, the processing device 120 may determine that the masking value as a verified masking value. The processing device 120 may determine the masking template based on the verified masking value. In response to determining that the masking value does not satisfy the data type of the tag, the processing device 120 may generate a reminder. The reminder may be in the form of text, voice, a picture, a video, a haptic alert, or the like, or any combination thereof. In some embodiments, the reminder may indicate existence of the situation that masking value does not satisfy the data type of the tag and/or which portion of the masking value does not satisfy the data type of the tag. The processing device 120 (or the user) may modify the masking value. The processing device 120 may verify a modified masking value until it is determined that the modified masking value satisfies the data type of the tag. The processing device 120 may determine the modified masking value as a verified masking value. The processing device 120 may determine the masking template based on the verified masking value.

Accordingly, by verifying the masking value in the masking template to ensure that the format of the masking value corresponding to the masking mode for the tag satisfies the data type of the tag, which may guarantee the accuracy and rationality of the masking template, and may improve the accuracy and efficiency of the data masking process.

In some embodiments, multiple masking templates may be generated based on a trained machine learning model. For example, the tags and the data type of the tags may be inputted into the trained machine learning model and the trained machine learning model may output the masking values of the tags. The trained machine learning model may be obtained by training a machine learning model (e.g., a deep neural network model, a recurrent neural network model, a long short term memory network model, a generative adversarial network model, etc.) using a training set of data (e.g., a training set of inputs each having a known output). The training set of data may include a plurality of training samples, and each of the plurality of training samples may include sample input data and one or more reference outputs (also referred to as known outputs). The sample input data may include tag samples. In some embodiments, the sample input data may also include the data types of the tag samples. The reference output may include a reference masking values of the tag samples. The reference masking values of the tag samples may be determined manually.

In some embodiments, each of the multiple masking templates may be evaluated to obtain an evaluation result. The evaluation result may indicate a de-identification quality using the mask template. In some embodiments, the evaluation result may include a de-identification rate (also referred to as masking rate). The de-identification rate refers to the proportion of data or data objects within a given dataset (e.g., the DICOM file) that have undergone de-identification processing. The processing device 120 may determine whether a masking template satisfies a condition, and in response to determining that the masking template does not satisfy the condition, the processing device 120 may adjust the masking template according to the evaluation result or according to the input of a user. Determining whether a masking template satisfies a condition may include determining whether the de-identification rate exceeds a de-identification rate threshold. In response to determining that the de-identification rate exceeds the de-identification rate threshold, the processing device may determine that the masking template satisfies the condition; and in response to determining that the de-identification rate does not exceed the de-identification rate threshold, the processing device may determine that the masking template does not satisfy the condition.

In some embodiments, the de-identification rate may be determined based on target tags. The target tags may be system default settings that are needs to be masked. The processing device may determine a ratio of a count of tags in the mask template that are modified and a count of the target tags as the de-identification rate. In some embodiments, the processing device may allocate a score to each of the target tags according to an importance of the target tags. The processing device may determine a ratio of a total score of the tags in the mask template that are modified and a total score of the target tags as the de-identification rate. The importance of a tag and/or the de-identification rate threshold may be a default setting of the system and the score of each tag may be determine according a default rule associated with the importance of the target tags.

In some embodiments, the evaluation result may include a quality score of the masking template. The quality score of the masking template may be related to one or more evaluation metrics, such an a compliance metric, an utility metric, an operational efficiency metric, or the like, or a combination thereof. Determining whether a masking template satisfies a condition may include determining whether the quality score exceeds a score threshold. In response to determining that the quality score exceeds the score threshold, the processing device may determine that the masking template satisfies the condition; and in response to determining that the quality score does not exceed the score threshold, the processing device may determine that the masking template does not satisfy the condition. The score threshold may be a default setting of the system or set by a user.

The compliance metric may include a direct identifier clearance rate (i.e., a proportion of identifiers in a target list (e.g., the 18 HIPAA identifiers) that have been successfully removed or de-identified), the private data element residual rate (i.e., the proportion of residual private data elements (those with an odd Group number) remaining in the DICOM file relative to the number before de-identification), etc. The utility metric may include a critical clinical attribute retention rate (i.e., a proportion of data elements that must be retained for specific research purposes (e.g., image geometric parameters, pixel transformation parameters), a data consistency error rate (i.e., a proportion of files where the relational data links within the same patient or the same study are broken), etc. The operational efficiency metric may include de-identification task success rate (i.e., a proportion of files successfully processed by the de-identification task without throwing errors), a pixel data burned-in area clearance rate (i.e., for images containing burned-in text, the proportion of the successfully detected and cleared burned-in area relative to the total image area (can be calculated by comparing pre- and post-de-identification images using computer vision algorithms), etc.

In some embodiments, the quality score may be a weighted average of the scores of different evaluation metrics. Each of the evaluation metrics may have a weight for weighting the scores of the evaluation metric.

In some embodiments, the evaluation result of a masking template may be determined based on multiple testing samples. Each of the testing samples may include a DICOM file. The processing device may perform masking processing on each testing sample to obtain a processed sample (i.e., a masked DICOM file). Each of the evaluation metrics may be calculated based on the testing sample and the processed sample to obtain the score of each of the evaluation metrics.

In 530, the processing device 120 (e.g., the masking module 430) may mask the data in the at least one original file based on the masking template, to generate at least one target file.

In some embodiments, the processing device 120 may obtain a masking request from a user. For example, the user may send the masking request to the processing device 120 by clicking one or more keys and/or buttons (e.g., the button 850 as illustrated in FIG. 8) in a query interface (e.g., the query interface 800 as illustrated in FIG. 8) via a mouse. The processing device 120 may mask the data in the at least one original file based on the masking request according to the masking template.

In some embodiments, for each tag of a plurality of tags in the at least one original file, the processing device 120 may mask (e.g., modify) at least part of a value of the tag based on a masking value corresponding to a corresponding masking mode for the tag in the masking template. In some embodiments, the value of the tag may include a plurality of characters (e.g., a mark, a sign, a symbol, a letter, a Chinese character). The processing device 120 may mask (e.g., modify) one or more characters of the plurality of characters of the value of the tag based on the masking value corresponding to the masking mode for the tag. For example, the processing device 120 may replace one or more characters of the plurality of characters of the value of the tag with the masking value corresponding to the masking mode for the tag. Further, the processing device 120 may generate the at least one target file based on at least one masked value (e.g., modified value) of the at least one tag of the plurality of tags.

In some embodiments, a first masking mode may be that all characters of the value of the tag are masked (e.g., modified) based on the masking value corresponding to the masking mode for the tag. For example, if a value of a tag of patient name in an original file is “Wang\hat{ }Xiaohong,” and a masking value corresponding to a masking mode for the tag of patient name is “anonymity,” the processing device 120 may modify the value of the tag of patient name from “Wang\hat{ }Xiaohong” to “anonymity.” That is, the value of the tag of patient name in a target file is “anonymity.”

In some embodiments, a second masking mode may be that one or more characters of the plurality of characters of the value of the tag are masked (e.g., modified) based on the masking value (e.g., a default value) corresponding to the masking mode for the tag. For example, if a value of a tag of patient name in an original file is “Wang\hat{ }Xiaohong,” and a masking value corresponding to a masking mode for the tag of patient name is “*,” the processing device 120 may replace one or more characters of the plurality of characters of the value of the tag of patient name with the masking value “*.” In some embodiments, the second masking mode may indicate which characters of the plurality of characters of the value of the tag needs to be replaced with the masking value “*.” In some embodiments, the second masking mode may indicate that one or more characters corresponding to the last name of patient in the value of the tag of patient name need to be replaced with the masking value “*” For example, the processing device 120 may modify the value of the tag of patient name from “Wang\hat{ }Xiaohong” to “****\hat{ }Xiaohong.” In some embodiments, the second masking mode may indicate that one or more characters corresponding to the first name of patient in the value of the tag of patient name need to be replaced with the masking value “*” For example, the processing device 120 may modify the value of the tag of patient name from “Wang\hat{ }Xiaohong” to “Wang\hat{ }********,” “Wang\hat{ }****hong,” or “Wang\hat{ }Xiao****,” “Wang\hat{ }Xi******,” or the like. In some embodiments, the second masking mode may indicate that the first two characters in the value of the tag of patient name need to be replaced with the masking value “*” For example, the processing device 120 may modify the value of the tag of patient name from “Wang\hat{ }Xiaohong” to “**ng\hat{ }Xiaohong.” In some embodiments, the one or more characters of the plurality of characters of the value of the tag of patient name may be replaced with the masking value “*” randomly. For example, the processing device 120 may modify the value of the tag of patient name from “Wang\hat{ }Xiaohong” to “W*n*\hat{ }Xia**ong.”

In some embodiments, a third masking mode may be that one or more characters of the plurality of characters of the value of the tag are masked (e.g., modified) based on the masking value (e.g., a random value) corresponding to the masking mode for the tag. For example, if a value of a tag of patient name in an original file is “Wang\hat{ }Xiaohong,” and a masking value corresponding to a masking mode for the tag of patient name is a random value, the processing device 120 may modify the value of the tag of patient name from “Wang\hat{ }Xiaohong” to a randomly generated value such as “ABcd\hat{ }12387,” “dfji\hat{ }hu78,” or the like. That is, the value of the tag of patient name in a target file is “ABcd\hat{ }12387,” “dfji\hat{ }hu78,” or the like.

In some embodiments, the processing device 120 may identify a language type of a value of a tag in the at least one original file. The language type may include the Chinese language, the English language, the French language, the Italian language, or the like. The processing device 120 may mask the value of the tag based on the language type of the value of the tag in the at least one original file and the masking mode for the tag. For example, if the value of the tag of patient name are Chinese characters, and the masking mode is that replacing the last name of patient in the value of the tag of patient name with a masking value, the processing device 120 may replace the first Chinese character or the first two Chinese characters in the value of the tag of patient name with the masking value. As another example, if the value of the tag of patient name are English characters, and the masking mode is that replacing the last name of patient in the value of the tag of patient name with a masking value, the processing device 120 may replace a plurality of characters corresponding the last name of the patient in the value of the tag of patient name with one or more masking values.

In some embodiments, different target files may be generated by masking a same original file based on different masking modes (e.g., the first masking mode, the second masking mode, the third masking mode) and corresponding masking values. That is, masked data in different target files generated by masking a same original file based on different masking modes and corresponding masking values may be different.

In some embodiments, a corresponding target file may be generated by masking an original file based on at least one masking mode (e.g., the first masking mode, the second masking mode, the third masking mode). A plurality of copy files of the corresponding target file may be generated and uploaded to a plurality of terminals (e.g., the terminal 140). A user may obtain a copy file of the corresponding target file from at least one terminal of the plurality of terminals based on a type of the terminal (e.g., the mobile device 141, the tablet computer 142, the laptop computer 143, etc.), a location of the user, an actual requirement, or the like.

It should be noted that the masking modes and the masking values described above are merely provided for the purposes of illustration, and not intended to limit the scope of the present disclosure. The masking template may include other masking modes. The value of the tag in the original file may be modified to any other form of masking value.

In 540, the processing device 120 (e.g., the storing module 440) may store the at least one target file.

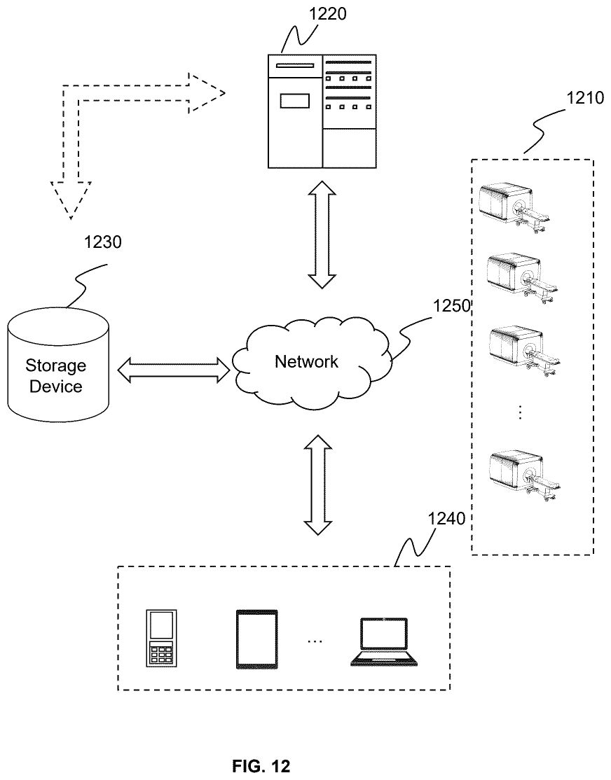

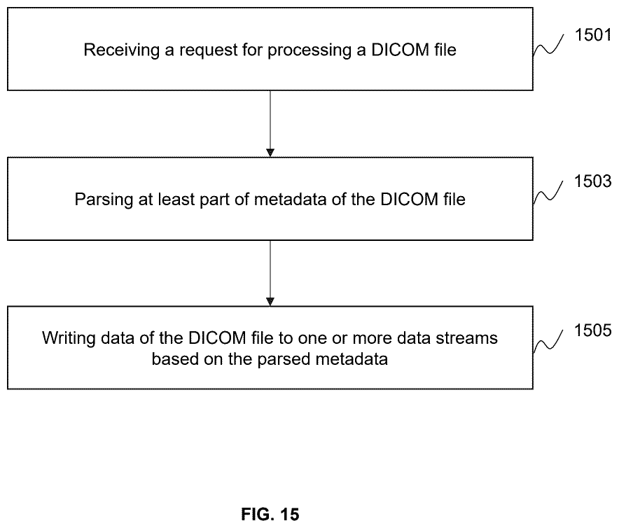

In some embodiments, the at least one target file may be transmitted by the processing device 120 according to process 1500 in FIG. 15 as described elsewhere in the present disclosure. For example, the at least one target file may be sent to a PACS server by parsing the metadata of the at least one target file, storing the parsed metadata of the at least one target file to a memory of the processing device, and writing the remaining data that is not parsed into a network stream for sending to the PACS server. More descriptions for transmission of the at least one target file may be found elsewhere in the present disclosure (e.g., FIGS. 12-25) and the descriptions thereof. In some embodiments, the processing device 120 may generate a plurality of target files by masking a plurality of original files using a masking template. The processing device 120 may store the plurality of target files based on a hierarchical relationship associated with the data in the plurality of original files (e.g., a tag-based hierarchical relationship of a plurality of tags of the plurality of original files). For example, the plurality of original files may be stored in a first folder in a first database (e.g., the PACS) of the medical system 100. The first folder may include a plurality of first-level directories A1. Each first-level directory A1 may correspond to a patient. That is, one or more original files (of the plurality of original files) associated with a specific patient may be stored in a corresponding first-level directory A1. Each first-level directory A1 may include one or more second-level directories B1. Each second-level directory B1 may correspond to a study of a patient. That is, one or more original files (of the plurality of original files) associated with a specific study of the patient may be stored in a corresponding second-level directory B1 of the first-level directory A1. Each second-level directory B1 may include one or more third-level directories C1. Each third-level directory C1 may correspond to a series of a study of a patient. That is, one or more original files (of the plurality of original files) associated with a specific series of the study of the patient may be stored in a corresponding third-level directory C1 of the second-level directory B1 of the first-level directory A1.

After the plurality of original files are masked based on the masking template to generate the plurality of target files, the processing device 120 may generate a second folder in a second database (e.g., the PACS) of the medical system 100. The second database may be the same as or different from the first database. In some embodiments, the second database may include a plurality of first-level directories A2. Each first-level directory A2 in the second database may correspond to a first-level directory A1 in the first database. One or more target files corresponding to one or more original files that is stored in the first-level directory A1 in the first database may be stored in a corresponding first-level directory A2 in the second database. As used herein, “a target file corresponding to an original file” refers to that the target file is generated by masking the original file. Each first-level directory A2 may include one or more second-level directories B2. Each second-level directory B2 in the second database may correspond to a second-level directory B1 in the first database. One or more target files corresponding to one or more original files that is stored in the second-level directory B1 in the first database may be stored in a corresponding second-level directory B2 in the second database. Each second-level directory B2 may include one or more third-level directories C2. Each third-level directory C2 in the second database may correspond to a third-level directory C1 in the first database. One or more target files corresponding to one or more original files that is stored in the third-level directory C1 in the first database may be stored in a corresponding third-level directory C2 in the second database.

In a traditional way, after value(s) of tag(s) other than an UID tag of an original file (e.g., a DICOM file) is modified in a data masking process and a target file is generated, since a value of the UID tag of the target file is the same as the value of the UID tag of the original file, which may violate the UID uniqueness principle of the DICOM file. When the target file is archived to a database (e.g., a PACS) containing the original file, archiving problems caused by duplicate UIDs may occur. In addition, in the traditional way, if values of the UID tag of a plurality of original files are modified in the data masking process and a plurality of target files are generated, since the hierarchical relationship associated with the data in the plurality of original files is unknown, the data in the plurality of target files may lose their hierarchical relationship. According to some embodiments of the present disclosure, the hierarchical relationship associated with the data in the plurality of target files may be the same as the hierarchical relationship associated with the data in the plurality of original files. The hierarchical relationship associated with the data in the plurality of target files may be unambiguous, thereby avoiding confusion of data in the plurality of target files. In addition, the time required for data masking may be saved, and the efficiency of data masking may be improved.

In some embodiments, the processing device 120 may determine a mapping relationship between the data in the original file and the data in the target file. For example, the processing device 120 may determine the mapping relationship between the data in the original file and the data in the target file by associating a value of a tag (e.g., a tag of SOP UID) in the original file with a masked value of the tag (e.g., the tag of SOP UID) in the target file. In some embodiments, the processing device 120 may record the mapping relationship between the data in the original file and the data in the target file in a table in the database (e.g., the PACS) of the medical system 100. In some embodiments, the processing device 120 may obtain the original file based on the target file and the mapping relationship between the data in the original file and the data in the target file.

In some embodiments, after the at least one target file is generated, the at least one original file may be deleted, which may save the storage space of the database of the medical system 100.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

In some embodiments, the processing device 120 may obtain a plurality of original files. The processing device 120 may obtain a masking template for the data in the plurality of original files. The masking template may include a plurality of tags of the plurality of original files, a plurality of masking modes corresponding to the plurality of tags, and a plurality of masking values corresponding to the plurality of masking modes. The processing device 120 may mask the data in the plurality of original file based on the masking template, to generate a plurality of target files. For example, for each tag of the plurality of tags, the processing device 120 may modify at least part of a value of the tag based on a masking value corresponding to a corresponding masking mode for the tag. The processing device 120 may generate the plurality of target files based on a plurality of modified values of the plurality of tags. According to some embodiments of the present disclosure, the plurality of original files may be masked using the masking template simultaneously, which may improve the efficiency of data masking. The data masking needs in many fields such as clinical medical teaching, medical communication, and artificial intelligence medical research may be satisfied.

In some embodiments, the processing device 120 may obtain at least one processed target file by performing a format conversion operation on the at least one target file. In some embodiments, the processing device 120 may perform the format conversion operation on the at least one target file according to one or more file format conversion algorithms. In some embodiments, the one or more file format conversion algorithms may be stored in a DICOM library. The file format conversion algorithms may include algorithms for converting a file of a DICOM format into a file of a BMP format, a JPG format, a PNG format, a TIFF format, or the like. For example, the processing device 120 may convert a target file of a DICOM format to a processed target file of a BMP format, a JPG format, a PNG format, a TIFF format, or the like.

In some embodiments, the processing device 120 may export the at least one target file and/or at least one processed target file. For example, the processing device 120 may export the at least one target file and/or at least one processed target file to a local disk, a mobile hard disk, a tape library, a network shared disk, or the like. As another example, the processing device 120 may export the at least one target file and/or at least one processed target file to a PowerPoint (PPT) document, a Word document, or the like.

In some embodiments, the processing device 120 may store the at least one target file and/or the at least one processed target file in a shared storage space. The storage space may include a local disk, a mobile hard disk, a tape library, a network shared disk, or the like.

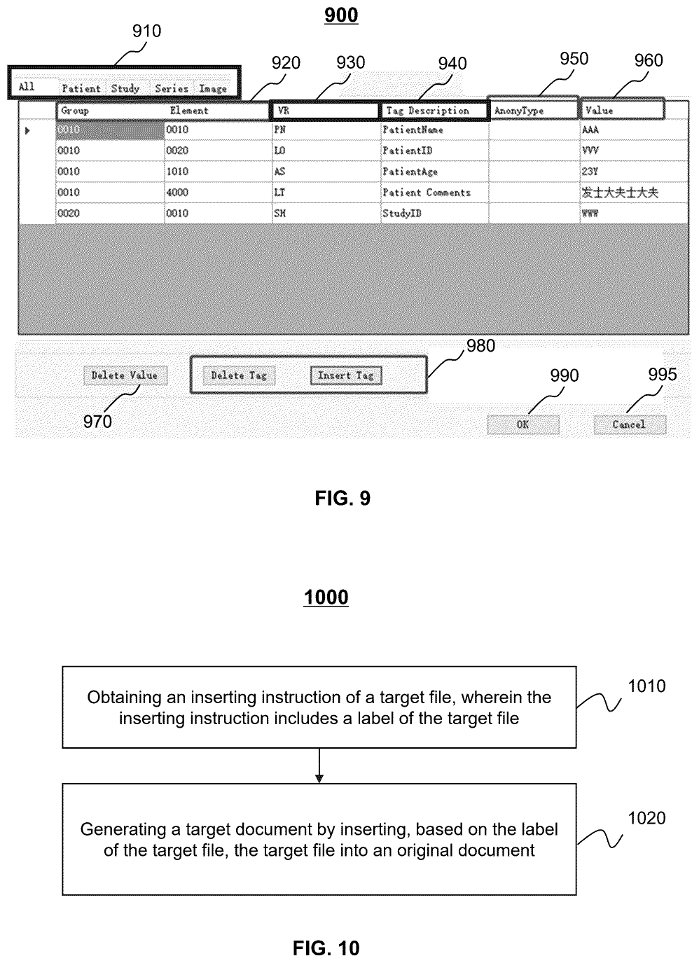

FIG. 10 is a flowchart illustrating an exemplary process for generating a target document according to some embodiments of the present disclosure. In some embodiments, process 1000 may be executed by the medical system 100. For example, the process 1000 may be implemented as a set of instructions (e.g., an application) stored in a storage device (e.g., the storage device 130, the storage device 220, and/or the storage 390). In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 1000. The operations of the illustrated process presented below are intended to be illustrative. In some embodiments, the process 1000 may be accomplished with one or more additional operations not described and/or without one or more of the operations discussed. Additionally, the order of the operations of process 1000 illustrated in FIG. 10 and described below is not intended to be limiting.

In 1010, the processing device 120 (e.g., the storing module 440) may obtain an inserting instruction of a target file.

In some embodiments, the processing device 120 may obtain the inserting instruction of the target file from a user. The inserting instruction of the target file may be a request for inserting the target file in a document. In some embodiments, the inserting instruction may include a label of the target file. The label of the target file may indicate that data in the target file has been masked. The label may include a letter, a number, a punctuation, or the like, or any combination thereof. In some embodiments, different target files may correspond to different labels.

In 1020, the processing device 120 (e.g., the storing module 440) may generate a target document by inserting, based on the label of the target file, the target file into an original document.

In some embodiments, the original document may include a PowerPoint (PPT) document, a Word document, or the like. In some embodiments, the processing device 120 may call a document interface to insert the target file into a target position in the original document based on the label of the target file included in the inserting instruction. In some embodiments, the target document may include one or more files of the original document and the target file.

According to some embodiments of the present disclosure, the target document may be generated by inserting the target file into the original document, which may facilitate usage including, e.g., clinical teaching, academic exchange and presentation, and/or image editing.

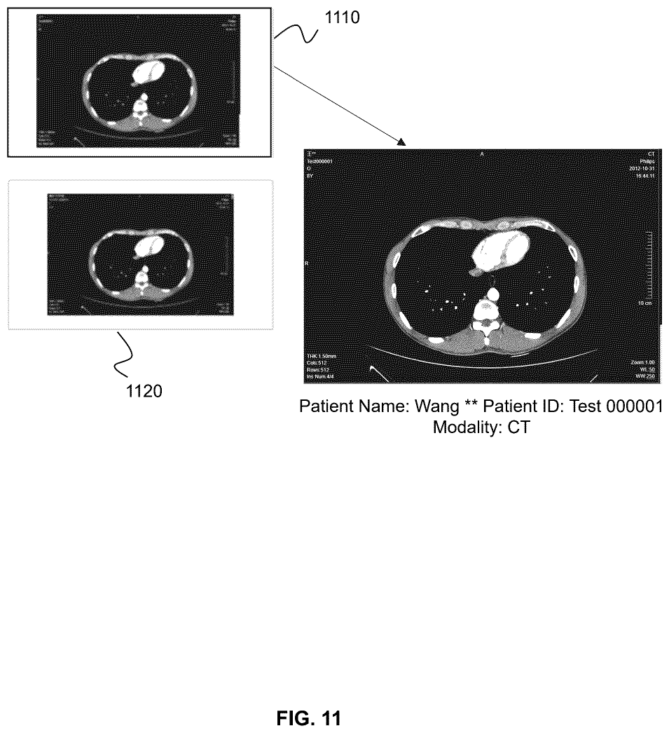

FIG. 11 is a schematic diagram illustrating an exemplary target document according to some embodiments of the present disclosure. As illustrated in FIG. 11, a target document 1100 (e.g., a PowerPoint (PPT) document) includes a first target file 1110 (e.g., a CT image) and a second target file 1120 (e.g., a CT image). A patient name in the first target file 1110 is masked by “Wang**”

Medical information systems (e.g., picture archiving and communication systems (PACS)) usually support the DICOM protocol. The DICOM protocol may be implemented by C++, C#, or java, and cannot fully support the reception and/or transmission of a large file. Generally, when receiving or sending a medical image file that follows the DICOM protocol, the PACS will save the full DICOM file into its memory or generate a local cache version of the DICOM file. DICOM files generated by different medical imaging devices are different. Many of the DICOM files are larger than 500 M (sometimes reaching several Gigabytes) which makes them difficult to be handled by traditional DICOM systems.

Sometimes, if several DICOM files need to be fully read through the memory, with the increase of the amount of the DICOM files and the frequencies of processing the DICOM files, the memory consumption would surge, leading to a slow response of the medical information system. If the DICOM files are read through a local cache instead of the memory, the consumption of input/output (I/O) read and write resources would increase, resulting in poor performance of the whole system. To improve the response time and performance, the system requires powerful hardware which would bring higher costs.

Transmission of large DICOM files is further prone to suffer from network transmission timeout and low network performance, resulting in file transmission failure. Therefore, it is desirable to provide systems and methods for DICOM file processing with improved performance for transmission of large DICOM files.

As used in the present disclosure, the DICOM protocol is an international standard for medical images and related information. The DICOM protocol defines a medical image format whose quality satisfies the clinical needs and can be used for data exchange. The DICOM protocol supports/provides a C-Store service. The C-Store service includes a C-Store SCP (service class provider) and a C-Store SCU (service class user). The C-Store SCP is a service end that supports DICOM file reception. The C-Store SCU is a client end that supports sending DICOM files. For archiving or storing a DICOM file, the C-Store SCP generally parses data of the DICOM file received from network stream(s) through the memory of the C-Store SCP, and then writes the parsed data from the memory to a disk or outgoing network stream(s). In such cases, the memory usage of the service end may surge with the size of the received DICOM file, which may lead to the collapse of the service end if too many such files are processed. For sending a DICOM file, the C-Store SCU (e.g., an image device, a terminal) may read data of the DICOM file through a memory of the C-Store SCU, and then write the data from the memory to network stream(s). In such cases, memory usage of the client end may surge with the size of the DICOM file, and cause system failure or unacceptable performances.

Generally, in the above scenarios, as the size of the DICOM file becomes larger, it is necessary to continuously improve the hardware configuration to ensure the normal operation of the system (e.g., the PACS), which increases hardware costs. In addition, a lot of unused data of the DICOM file may be parsed, resulting in the overall performance of data storage and the subsequent data processing being low. Therefore, it is desirable to provide systems and methods for file processing, which can effectively solve the above problems and improve file transmission efficiency and/or performance.

An aspect of the present disclosure relates to systems and/or methods for DICOM file processing. The systems may obtain a request for processing a DICOM file. The systems may parse at least part of metadata of the DICOM file. The systems may further write data of the DICOM file to one or more data streams based on the parsed metadata. At least part of the data of the DICOM file written to the data stream(s) is not parsed. For example, the systems may write the parsed metadata and pixel data of the DICOM file to the data stream(s), and some of the pixel data is not parsed.

According to some embodiments of the present disclosure, when a local file system (e.g., the PACS) receives the DICOM file, only part of the DICOM file (e.g., the metadata of the DICOM file) may be parsed and written to the memory of the PACS, and remaining part of the DICOM file (e.g., the pixel data of the DICOM file) may not be parsed and not be written to the memory of the PACS. For example, the remaining part of the DICOM file may be directly written to the data stream(s) for storing in a disk of the PACS without through the memory. Generally, the amount of the metadata of the DICOM file is small (e.g., less than 16 Kb) while the amount of the pixel data of the DICOM file is large (e.g., greater than 1500 M). Sometimes, it is not necessary to parse all data of the DICOM file to the memory or cache of the PACS, therefore reducing the memory consumption, maintaining stable usage of the memory, and improving the system performance.

Another aspect of the present disclosure relates to systems and/or methods for DICOM file processing. The systems may obtain a DICOM file. The systems may obtain pixel data of the DICOM file. The systems may segment the pixel data of the DICOM file into a plurality of pixel groups. The systems may further generate, based on the plurality of pixel groups and the DICOM file (e.g., metadata of the DICOM file), a plurality of DICOM sub-files. Further, the systems may write data of the plurality of DICOM sub-files to one or more data streams for further processing.

Some existing technologies may perform physical division on the DICOM file for improving transmission performance. However, the DICOM file after division may not have complete label information (e.g., metadata) of the DICOM file. In such cases, a client end or a server end that receives a division of the DICOM file cannot obtain the label information from the division, resulting in that medical images in the DICOM file cannot be displayed until all divisions of the DICOM file are received and combined. According to some embodiments of the present disclosure, the DICOM file may be divided to generate a plurality of DICOM sub-files. Each of the DICOM sub-files may include complete label information (e.g., the metadata) of the DICOM file and support the DICOM protocol. Accordingly, the plurality of DICOM sub-files can be transferred in a parallel fashion according to the DICOM protocol, thereby helping the client end or the server end to normally display the transmitted medical images during transmission.

FIG. 12 is a schematic diagram illustrating an exemplary file transmission system according to some embodiments of the present disclosure. In some embodiments, the file transmission system 1200 may be configured to achieve transmission of DICOM files. As illustrated in FIG. 22, the file transmission system 1200 may include, a processing device 1220, the network 1250, terminals 1240, and a storage device 1230. The file transmission system 1200 may support a C-store serves and a DICOM protocol. In some embodiments, the file transmission system 1200 may further include multiple imaging devices 1210 configured to acquire image data. The image data may be processed to generate DICOM files. Each of the multiple imaging devices 1210 may serve as the C-Store SCU. Each of the multiple imaging devices 1210 may send DICOM files to the processing device 120. In some embodiments, each of the terminals 1240 may serve as a C-store SCU and/or a C-store SCP. In other words, a terminal 1240 may send a DICOM file to the processing device 1220 and/or receive a DICOM file from other terminals. The processing device 120 may be a server serving as a C-store SCP for receiving multiple DICOM files acquired by the multiple imaging devices. The multiple imaging devices 1210 may be in a private network (i.e., the network 1250). For example, the multiple imaging devices 1210 may be belonged to the same hospital. As another example, the multiple imaging devices 1210 may be belonged to different branches of the same hospital.

In some embodiments, the file transmission system 1200 may be a part of an image file system (e.g., a local file system such as the PACS) for file transmission in the image file system (e.g., a local file system such as the PACS). The image file system may include an imaging acquisition system including the multiple imaging devices 1210, a network communication system including the network 1250, a data storage system including the storage device 1230, the processing device 1220, a database, etc., and a workstation (e.g., a PACS workstation) implemented on each of the terminals 1240. The workstation may be installed with a client application for facilitating interaction between users and the image file system. For example, the workstation may receive images from one of the multiple imaging devices 1210 and/or the data storage system, and then process (e.g., display and operate) the received images, etc., according to an input of a user.

In some embodiments, the image file system may be implemented on a microservices architecture. The image file system implemented on the microservices architecture may provide multiple microservices via independent service processes. Each of the multiple microservices may be provided by an software unit implemented on a server (e.g., the processing device 1220). For example, the microservices architecture may include an access & communication layer providing a DICOM gateway service. The access & communication layer may be configured to implement the DICOM protocol (e.g., acting as a C-STORE SCP) to receive DICOM data from the multiple with high concurrency and serve as the system's entry point. As another example, the microservices architecture may include a data & service layer providing a storage management service for managing the storage and search of DICOM file, a metadata indexing service for managing the database, a workflow engine service for performing tasks according to rules, etc. As still another example, the microservices architecture may include a processing & intelligence layer providing an image processing service, an AI inference service, etc. As still another example, the microservices architecture may include an application & interface layer (also referred to as a client layer) for providing a Web API gateway that serves as the unified entry point for all client interactions, handling authentication, authorization, routing, rate limiting, and logging. In some embodiments, the processing & intelligence layer and the data & service layer may be integrated into a same layer, called an application and service layer.

In some embodiments, the image file system may be implemented on a distributed architecture. For example, the data storage system may include a distributed storage system including multiple nodes. Each of the multiple nodes may include a server. A DICOM file may be stored to the multiple nodes (e.g., a disk) in a server. As another example, the processing & intelligence layer in the microservices architecture may be implemented on a distributed computation system including multiple servers. A task for the processing & intelligence layer providing an image processing service, an AI inference service, etc., may be divided into multiple sub-tasks performed by the multiple servers. As stilled another example, the multiple microservices may be implemented by a distributed system including a server cluster.

The processing device 1220 may process data and/or information. The data and/or information may be obtained from the terminals 1240 and/or the storage device 1230. In some embodiments, the processing device 1220 may obtain a request for processing a DICOM file, e.g., from the terminal 1240. The request may be data stream(s) including how to process the DICOM file and the DICOM file. The processing device 1220 may parse at least part of metadata of the DICOM file. The processing device 1220 may write data of the DICOM file to one or more data streams based on the parsed metadata. At least part of the data of the DICOM file written to the data stream(s) may be not parsed. For example, the processing device 1220 may write the parsed metadata and pixel data of the DICOM file (that is not parsed) to the data stream(s) for storing and/or forwarding. As another example, the processing device 1220 may parse the pixel data of the DICOM file. The processing device 1220 may segment the pixel data of the DICOM file into a plurality of pixel groups. The processing device 1220 may generate, based on the plurality of pixel groups and the DICOM file, a plurality of DICOM sub-files. The processing device 1220 may transfer the plurality of DICOM sub-files in a parallel fashion according to a DICOM protocol. For instance, the processing device 1220 may transfer the plurality of DICOM sub-files by writing data of the plurality of DICOM sub-files to the one or more data streams.

In some embodiments, the DICOM file may include image data of a subject, e.g., medical image data acquired by a medical imaging device. For example, after the medical imaging device performs a scan of the subject or the portion thereof, the medical imaging device may generate the image data of the subject or the portion thereof. The image data of the subject or the portion thereof may need to be transmitted to the image file system (e.g., a local file system such as the PACS) for processing (e.g., storing, transmitting, and/or forwarding). The image data and/or reports of the subject in a form of an electronic file may be transmitted digitally from/to the image file system, such that a user (e.g., an authorized user such as a doctor, a third party, etc.) can retrieve the image data for diagnosis and/or research purposes from or send the image data to the image file system via the terminal 1240. For instance, the image file system may include a picture archiving and communication system (PACS). The PACS may be a medical imaging technology configured to provide storage and access to image data from multiple modalities. In some embodiments, the processing device 1220 may be part of the image file system (e.g., the PACS). In some embodiments, the image data may be transmitted to/from the image file system according to a preset transmission protocol (e.g., a DICOM protocol).

In some embodiments, the processing device 1220 may be a single server or a server group. The server group may be centralized or distributed. In some embodiments, the processing device 1220 may be local or remote. For example, the processing device 1220 may access information and/or data stored in the terminal(s) 130, and/or the storage device 1230 via the network 1250. As another example, the processing device 1220 may be directly connected to the terminals 1240, and/or the storage device 1230 to access stored information and/or data. In some embodiments, the processing device 1220 may be implemented on a cloud platform. For example, a cloud platform may include a private cloud, a public cloud, a hybrid cloud, a community cloud, a distributed cloud, an inter-cloud, and a multi-cloud, or the like, or any combination thereof. In some embodiments, the processing device 1220 may be implemented by a computing device 200 having one or more components as illustrated in FIG. 2 or be a portion of the terminal 1240.

The network 1250 may include any suitable network that can facilitate the exchange of information and/or data of the file processing system. In some embodiments, one or more components of the file processing system (e.g., the terminal 1240, the processing device 1220, the storage device 1230, etc.) may communicate information and/or data with one or more components of the file processing system 100 via the network 1250. The network 1250 may include a public network (e.g., the Internet), a private network (e.g., a local area network (LAN), a wide area network (WAN)), etc.), a wired network (e.g., an Ethernet network), a wireless network (e.g., an 1802.11 network, a Wi-Fi network, etc.), a cellular network (e.g., a Long Term Evolution (LTE) network), a frame relay network, a virtual private network (“VPN”), a satellite network, a telephone network, routers, hubs, server computers, or the like, or a combination thereof. For example, the network 1250 may include a wireline network, an optical fiber network, a telecommunication network, a local area network, a wireless local area network (WLAN), a metropolitan area network (MAN), a public telephone switched network (PSTN), a Bluetooth™ network, a ZigBee™ network, a near field communication (NFC) network, or the like, or a combination thereof. In some embodiments, the network 1250 may include one or more network access points. For example, the network 1250 may include wired and/or wireless network access points, such as base stations and/or Internet exchange points, through which one or more components of the file processing system may be connected to the network 1250 to exchange data and/or information.

The terminal 1240 may input/output signals, data, information, etc. In some embodiments, the terminal 1240 may enable user interaction with the processing device 1220. In some embodiments, the terminal 1240 (e.g., a mobile device, a tablet computer, a laptop computer, etc.) may communicate with the processing device 1220 via the network 1250. For example, the terminal 1240 may send a request for processing a DICOM file according to a user instruction to the processing device 1220. As another example, a user may access the image file system for obtaining a DICOM file via the terminal 1240. For instance, the terminal 1240 may obtain user input information (e.g., a search query or a file transmission request) through an input device (e.g., a keyboard, a touch screen, a brain wave monitoring device), and transmit the input information to the processing device 1220 for obtaining the DICOM file stored in the image file system. As still another example, the terminal 1240 may generate a plurality of DICOM sub-files based on a DICOM file. The terminal 1240 may transmit the plurality of DICOM sub-files to the processing device 1220 for further processing. In some embodiments, the terminal 1240 may display image data in a DICOM file on a display device (e.g., a screen of the terminal 1240).

In some embodiments, the terminal 1240 may include a computing device as described elsewhere in the present disclosure (e.g., the computing device 200 as described in FIG. 2) or a mobile device as described in the present disclosure. In some embodiments, the terminal 1240 may be a workstation installed with an application for interaction between a user and the file transmission system.

The storage device 1230 may store data (e.g., image data of a subject, a DICOM file), instructions, and/or any other information. In some embodiments, the storage device 1230 may store data obtained from the terminals 1240 and/or the processing device 1220. For example, the storage device 1230 may store data of the DICOM file received by the processing device 1220. In some embodiments, the storage device 1230 may store data and/or instructions executed or used by the processing device 1220 to perform exemplary methods described in the present disclosure. In some embodiments, the storage device 1230 may include a mass storage device, a removable storage device, a volatile read-write memory, a read-only memory (ROM), or the like, or any combination thereof. In some embodiments, the storage device 1230 may be a part of the image file system. For example, the storage device 1230 may include a memory (e.g., a volatile read-write memory) as the memory of the image file system. The memory of the image file system may store the metadata of the received DICOM file. As another example, the storage device 1230 may include a mass storage device or a removable storage device as the disk of the image file system. The disk of the image file system may store data of the received DICOM file (e.g., the metadata and the pixel data of the received DICOM file.

In some embodiments, the storage device 1230 may be connected to the network 1250 to communicate with one or more components (e.g., the processing device 1220, the terminal 1240, etc.) of the file transmission system. One or more components of the file transmission system may access the data or instructions in the storage device 1230 via the network 1250. In some embodiments, the storage device 1230 may be a part of the processing device 1220. Alternatively, the storage device 1230 may be independent and directly or indirectly connected to the processing device 1220. For example, when the storage device 1230 includes the memory and the disk of the image file system. The memory may be a part of the processing device 1220, and the disk may be directly or indirectly connected to the processing device 1220 (e.g., via the network 1250).

In some embodiments, both the processing device 1220 and the storage device 1230 may be parts of the image file system (e.g., a local file system such as the PACS). In such cases, the image file system may also be referred to as a server end, and the terminal(s) may also be referred to as a client end. The server end and the client end may achieve communication (e.g., file transmission) via the network 1250.

It should be noted that the above description regarding the file transmission system is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the file transmission system may include one or more additional components and/or one or more components of the file transmission system described above may be omitted. In some embodiments, a component of the file transmission system may be implemented on two or more sub-components. Two or more components of the file transmission system may be integrated into a single component.

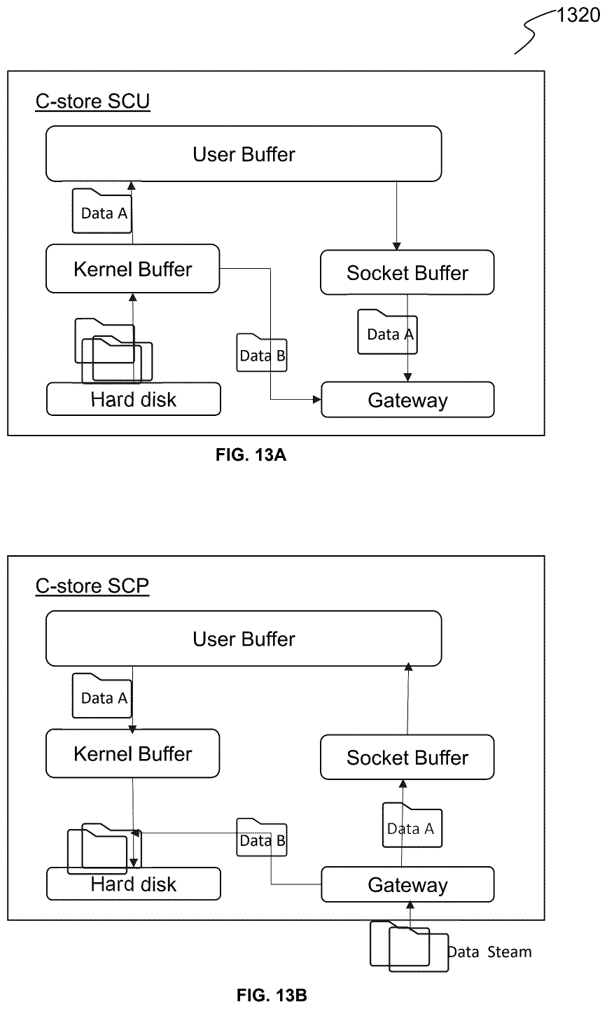

FIG. 13A is a schematic diagram illustrating an exemplary C-store SCU of a file transmission system according to some embodiments of the present disclosure.

The C-Store SCU is a client end that supports sending DICOM files. The C-Store SCU is a service end that supports DICOM file reception. The C-Store SCU may be a server (e.g., a PACS server) or a terminal including a processing device (e.g., a CPU), memory, a gateway, and a hard disk. The memory may be divided into a kernel space and a user space. The kernel space may include a kernel buffer for a kernel implemented on the processing device, and the user space may include a user buffer (also referred to as an application buffer) for a SCU process. The SCU process (i.e., application) may run in the user space. The SCU process cannot directly access the kernel buffer. For the application to process a data stream (e.g., parsing the DICOM protocol, validating the data stream), data in the data stream must be copied into memory allocated to the user space (i.e., the user buffer) that the application has permission to access. This is mandated by the memory protection model.

The C-Store SCU may read a data stream including a DICOM file from a hard disk (also referred to as disk for brevity) and then send the DICOM file to the C-Store SCP. Generally, for archiving and sending the DICOM file, the C-Store SCU generally parses the data stream received from network stream(s) through the memory of the C-Store SCU, and then send the parsed data from the memory to a outgoing network stream. For example, the kernel running in the kernel space may copy the data stream into a kernel buffer in the kernel space from the hard disk because all operations on the hard disk must go through the kernel, and the application running in the user space may read the data stream from the kernel buffer in the kernel space to the user buffer for the application to process the data stream (e.g., parsing the DICOM protocol, validating the data stream). Then after the application processes the data stream, the application may write the data stream into the socket buffer for sending to the C-Store SCP through the gateway. The application running in the user space cannot write to the gateway directly. The kernel needs to place data into its own buffer to enable efficient, batched writes to the gateway. Finally, the gateway may send the data stream to the C-Store SCU. In such cases, the memory usage of the C-Store SCU may surge with the size of the received DICOM file, which may lead to the collapse of the C-Store SCU if too many such files are processed by the application.

According to some embodiments of the present disclosure, as shown in FIG. 13A, the kernel may copy the metadata (i.e., data A) into the kernel buffer in the kernel space, and the application running in the user space may copy or read the data A from the kernel buffer in the kernel space to the user buffer for the application to process (e.g., parsing the DICOM protocol). The data A then may be written from the user buffer to the socket buffer and then copied to the gateway. The remaining data excluding the metadata (i.e., data B) may be directly transmitted to the gateway to be combined with the data A to form the DICOM file using a zero-copy technique. The data B may be not stored to the user space. The zero-copy technique may include a memory mapping technique, a sendfile technique, or the like, or a combination thereof.

FIG. 13B is a schematic diagram illustrating exemplary C-store SCP of a file transmission system according to some embodiments of the present disclosure.

The C-Store SCP is a service end that supports DICOM file reception. The C-Store SCP may be a server including a processing device (e.g., a CPU), memory, a gateway, and a hard disk. The memory may be divided into a kernel space and a user space. The kernel space may include a kernel buffer for a kernel implemented on the processing device, and the user space may include a user buffer (also referred to as an application buffer) for a SCP process. The SCP process (i.e., application) may run in the user space. The SCP process cannot directly access the kernel buffer. For the application to process a data stream (e.g., parsing the DICOM protocol, validating the data stream), data in the data stream must be copied into memory allocated to the user space that the application has permission to access. This is mandated by the memory protection model.

The C-Store SCP may receive a data stream including a DICOM file from a C-Store SCU and then store the DICOM file to the hard disk. Generally, for archiving and storing the DICOM file, the C-Store SCP generally parses the data stream received from network stream(s) through the memory of the C-Store SCP, and then writes the parsed data from the memory to a disk or outgoing network stream(s). For example, the kernel running in the kernel space may copy the data stream into a socket buffer in the kernel space through a direct memory access (DMA), and the processing device (CPU) or the application running in the user space may copy the data stream from the socket buffer in the kernel space to the user buffer for the application to process the data stream (e.g., parsing the DICOM protocol, validating the data stream). Then after the application processes the data stream, the application may copy the data stream into the kernel buffer for writing into the hard disk because all operations on the hard disk must go through the kernel. The application cannot write to the hard disk directly. The kernel needs to place data into its own buffer to enable efficient, batched writes to the hard disk. Finally the kernel may write the data stream to the hard disk. In such cases, the memory usage of the C-Store SCP may surge with the size of the received DICOM file, which may lead to the collapse of the C-Store SCP if too many such files are processed. According to some embodiments of the present disclosure, as shown in FIG. 13B, the kernel may copy the metadata (i.e., data A) into the socket buffer in the kernel space from the gateway, and the application running in the user space may read or access the data A from the socket buffer in the kernel space to the user buffer for the application to process (e.g., parsing the DICOM protocol). The data A then may be copied or written from the user buffer to the kernel buffer and then copied to the hard disk by the kernel. The remaining data excluding the metadata (i.e., data B) may be directly transmitted to the hard disk to be combined with the data A to form the DICOM file using a zero-copy technique. The data B may be not stored to the user space. The zero-copy technique may include a memory mapping technique, a sendfile technique, or the like, or a combination thereof.

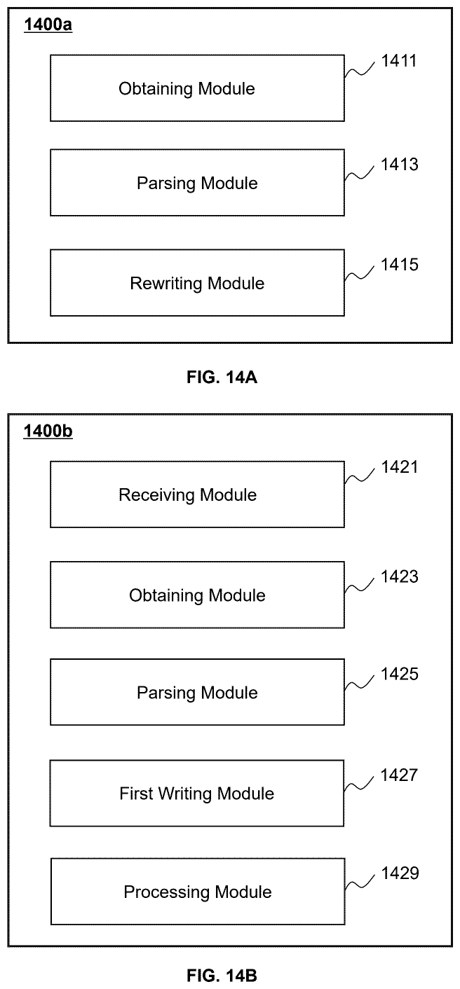

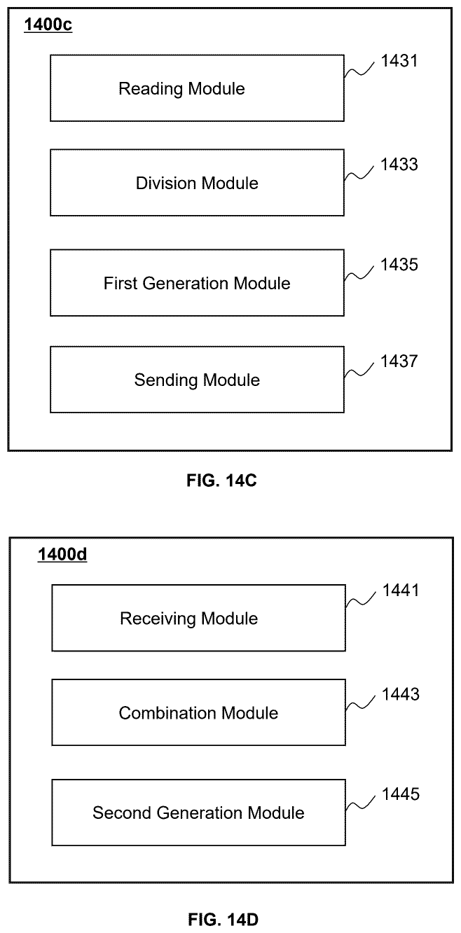

FIGS. 14A-14D are schematic diagrams illustrating exemplary processing devices according to some embodiments of the present disclosure.

As shown in FIG. 14A, the processing device 1400a may include an obtaining module 1411, a parsing module 1413, and a rewriting module 1415.

The obtaining module 1411 may be configured to obtain image/information from one or more components of the file transmission system 1200. For example, the obtaining module 1411 may receive a request for processing a DICOM file. The request may be carried by a data stream. The data stream may include instructions about how to process the DICOM file and/or data of the DICOM file. More descriptions regarding receiving the request may be found elsewhere in the present disclosure (e.g., operation 1501 in FIG. 15 and relevant descriptions thereof.

The parsing module 1413 may be configured to parse information related to the request (e.g., the information and/or data of the data stream which carries the request). For example, the parsing module 1413 may parse the instruction about how to process the DICOM file. As another example, the parsing module 1413 may parse metadata of the DICOM file from the data stream. As still another example, the parsing module 1413 may parse pixel data of the DICOM file from the data stream. More descriptions regarding the parsing operation may be found elsewhere in the present disclosure (e.g., operations 1503 and 1505 and relevant descriptions thereof).

The rewriting module 1415 may be configured to write data of the DICOM file to one or more data streams. For example, the rewriting module 1415 may write the parsed metadata of the DICOM file to the data stream(s). As another example, the rewriting module 1415 may write parsed pixel data and/or unparsed pixel data to the data stream(s). More descriptions regarding the writing operation may be found elsewhere in the present disclosure (e.g., operation 1505 and relevant descriptions thereof).

As shown in FIG. 14B, the processing device 1400b may include a receiving module 1421, an obtaining module 1423, a parsing module 1425, a first writing module 1427, and a processing module 1429.

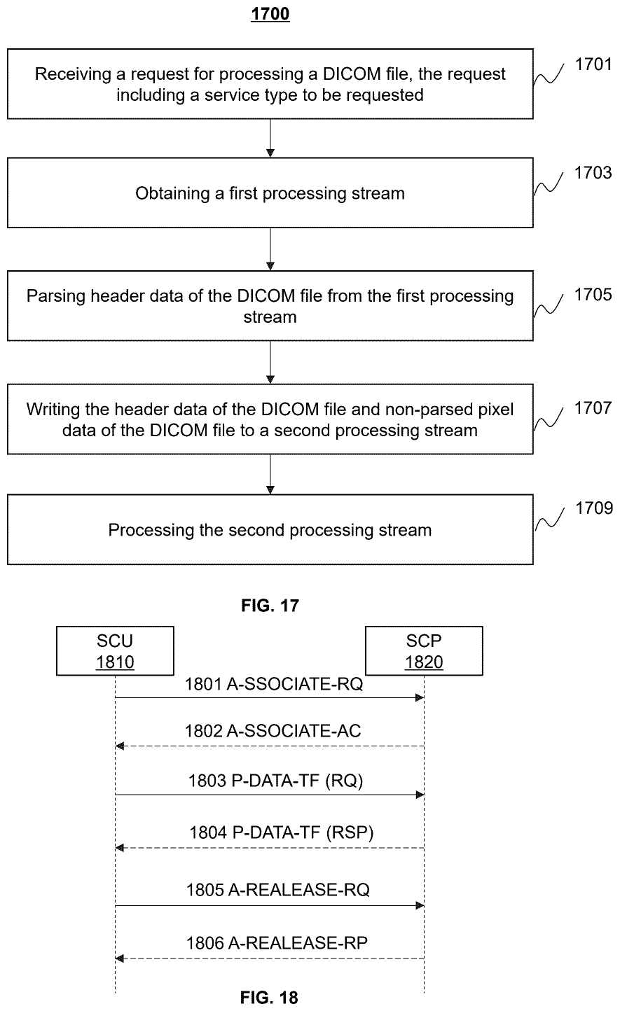

The receiving module 1421 may be configured to receive a request for processing a DICOM file, e.g., from a client end (e.g., the terminal 1240). The request may include a service type (e.g., a kind of server that is requested). The service type may include a storage service, a forwarding service, a query service, or the like, or any combination thereof. More descriptions regarding the request may be found elsewhere in the present disclosure (e.g., operation 1701 in FIG. 17 and relevant descriptions thereof).

The obtaining module 1423 may be configured to obtain a first processing stream. More descriptions regarding the first processing stream may be found elsewhere in the present disclosure (e.g., operation 1703 in FIG. 17 and relevant descriptions thereof).

The parsing module 1425 may be configured to parse the header data in the first processing stream. The header data may include a recorded size (e.g., a recorded data length) of the unparsed medical image data. More descriptions regarding the parsing operation may be found elsewhere in the present disclosure (e.g., operation 1705 in FIG. 17 and relevant descriptions thereof).

The first writing module 1427 may be configured to write the parsed header data into a second processing stream. The second processing stream may contain unparsed medical image data in the first processing stream. Data sources of the unparsed medical image data written to the second processing stream may be from the first processing stream or be locally resourced. More descriptions regarding the writing operation may be found elsewhere in the present disclosure (e.g., operation 1707 in FIG. 17 and relevant descriptions thereof).

The processing module 1429 may be configured to process the second processing stream. For example, the processing module 1429 may send the second processing stream externally (e.g., to a real destination of the DICOM file) according to an instruction of the column storage database. More descriptions regarding the processing of the second processing stream may be found elsewhere in the present disclosure (e.g., operation 1707 in FIG. 17 and relevant descriptions thereof).

In some embodiments, when the service type is a storage service, the first processing stream may be a network stream sent by the terminal 1240, and the second processing stream may be a local file stream. In such cases, the processing device 1400b may further include a first determination module (not shown) and a second writing module (not shown). The first determination module may be configured to determine an actual data length of the unparsed medical image data and determine whether the actual data length of the unparsed medical image data is consistent with (e.g., equal to) the recorded data length of the unparsed medical image data. The second writing module may be configured to obtain the unparsed medical image data from the first processing stream when the recorded data length is consistent with (e.g., equal to) the actual data length, and write the unparsed medical image data into the second processing stream.

In some embodiments, when the service type is the forwarding service, the first processing stream may be a network stream sent by the terminal 1240, and the second processing stream may be a network stream forwarding externally. In such cases, the processing device 1400b may further include a third writing module (not shown) configured to write the medical image data stored locally into the second processing stream when there is locally stored medical image data that is the same as the unparsed medical image data. When there is no locally stored medical image data that is the same as the unparsed medical image data, the third writing module may obtain the unparsed medical image data from the first processing stream and write the unparsed medical image data into the second processing stream.

As shown in FIG. 14C, the processing device 1400c may include a reading module 1431, a division module 1433, a first generation module 1435, and a sending module 1437.

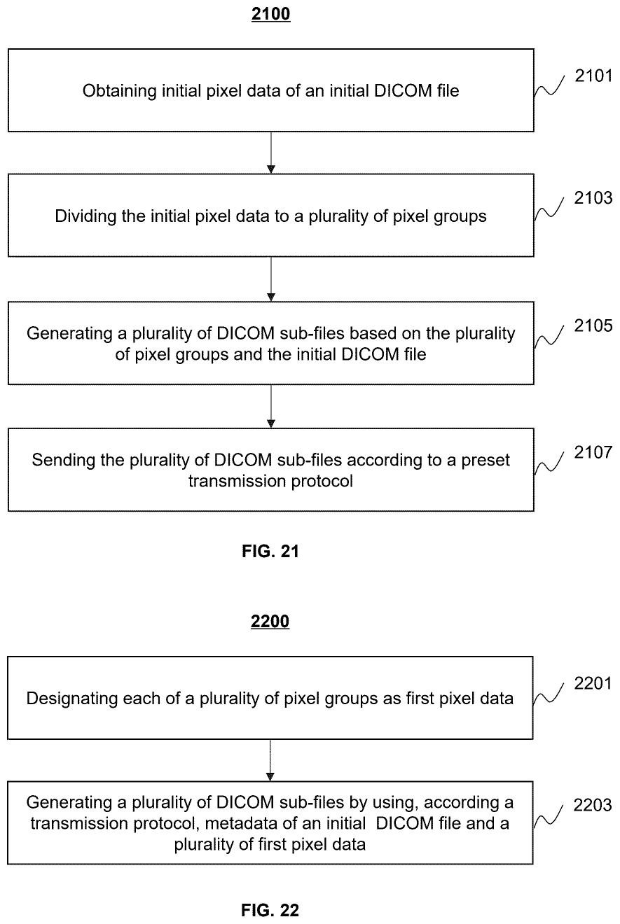

The reading module 1431 may be configured to obtain initial pixel data in an initial DICOM file. More descriptions regarding the initial pixel data may be found elsewhere in the present disclosure (e.g., operation 2101 in FIG. 21 and the relevant descriptions thereof).

The division module 432 may be configured to divide the pixel data into a plurality of pixel groups. More descriptions regarding the division operation may be found elsewhere in the present disclosure (e.g., operation 2103 in FIG. 21 and the relevant descriptions thereof).

The first generation module 1433 may be configured to generate a plurality of DICOM sub-files based on the plurality of pixel groups and the initial DICOM file. More descriptions regarding the generation of the DICOM sub-files may be found elsewhere in the present disclosure (e.g., operation 2105 in FIG. 21 and the relevant descriptions thereof).

The sending module 434 may be configured to send the plurality of DICOM sub-files according to a preset transmission protocol. More descriptions regarding the sending operation may be found elsewhere in the present disclosure (e.g., operation 2107 and FIG. 21 and the relevant descriptions thereof).

As shown in FIG. 24D, the processing device 1400d may include a receiving module 1441, a combination module 1443, and a second generation module 1445.

The receiving module 1441 may be configured to receive a plurality of DICOM sub-files and read pixel data of each of the plurality of DICOM sub-files. More description regarding the plurality of DICOM sub-files and the pixel data may be found elsewhere in the present disclosure (e.g., operation 2401 in FIG. 24) and relevant descriptions thereof).

The combining module 1443 may be configured to determine target pixel data by merging/combining a plurality of pixel data of the plurality of DICOM sub-files. More descriptions regarding the determination of the target pixel data may be found elsewhere in the present disclosure (e.g., operation 2403 in FIG. 24 and relevant descriptions thereof).

The second generation module 1445 may be configured to generate an initial DICOM file based on the target pixel data and one of the plurality of DICOM sub-files. More descriptions regarding the generation of the initial DICOM file may be found elsewhere in the present disclosure (e.g., operation 2405 in FIG. 24 and relevant descriptions thereof).

In some embodiments, the above modules may be different modules in a processing device, or may be a module that implements functions of two or more modules mentioned above. As illustrated above, processing devices 1400a, 1400b, and 1400d may be exemplary configurations of the processing device 1220. In some embodiments, the processing devices 1400a, 1400b, and 1400d may share one or more of the modules illustrated above. For instance, the processing devices 1400a, 1400b, and 1400d may be part of a same system and share a same module. For example, the obtaining module 1411, the receiving module 1421, the obtaining module 1423, and/or the receiving module 1441 may be a same module. In some embodiments, the processing devices 1400a-1400d may be different devices belonging to different parties. For example, the processing device 1400a, the processing device 1400b, and/or the processing device 1400d may belong to a server end (e.g., the C-Store SCP of the image file system). As another example, the processing device 1400c may belong to the server end (e.g., the C-Store SCU) or a client end (e.g., the terminal 1240).

FIG. 15 is a flowchart illustrating an exemplary process for DICOM file processing according to some embodiments of the present disclosure. In some embodiments, the process 1500 may be implemented as a set of instructions (e.g., an application) stored in a storage device (e.g., the storage device 1230, the storage device 220, and/or the storage 390). The processing device 1400a (e.g., the processor 210, the CPU 340, and/or one or more modules illustrated in FIG. 14A) may execute the set of instructions, and when executing the instructions, the processing device 1400a may be configured to perform the process 1500. The operations of the illustrated process presented below are intended to be illustrative. In some embodiments, the process 1500 may be accomplished with one or more additional operations not described and/or without one or more of the operations discussed. Additionally, the order of the operations of process 1500 illustrated in FIG. 15 and described below is not intended to be limiting. In some embodiments, operations of the process 1500 are described in connection with receiving a DICOM file from a client end (e.g., the terminal 1240). It should be noted that operations of the process 1500 may be applied to send a DICOM file as well. In some embodiments, operations of the process 1500 may be implemented by a server end such as an image file system (e.g., a local file system such as the PACS or the C-Store SCU of the local file system) of the file transmission system. For example, the processing device 1400a may be a part of the image file system. Alternatively, operations of the process 1500 may be implemented by a client end (e.g., the terminal 1240) of the file transmission system or an external system (e.g., an external file system) that can communicate with the file transmission system 1200 and supports the DICOM protocol.

In 1501, the processing device 1400a (e.g., the obtaining module 1411) may receive a request for processing a DICOM file.

In some embodiments, the DICOM file may store medical image data of an object (e.g., a patient) that is acquired from a scan of the object using an imaging device (e.g., the medical imaging device) in a DICOM format. The DICOM file may include metadata (also referred to as header or header data), pixel data (i.e., the medical image data), etc. The metadata of the DICOM file may include identification information relating to the medical image data and/or the object. The metadata may be organized as a standard series of tags. The series of tags may further be organized into groups of data elements. Different groups may correspond to different identifiers (IDs) and information. For example, a group with ID “0010” may contain patient information, e.g., the patient's name, the patient's identification number, the patient's birth date, etc. which correspond to different tags (i.e., with different tag identifiers (IDs)). As another example, a group with ID “0018” may contain acquisition information (e.g., acquisition parameters that are used to acquire the medical image data). As still another example, a group with ID “0028” may contain an image presentation and be responsible for the display of the medical image data. As a further example, a group with ID “0002” may contain file meta information (e.g., a transfer syntax, an abstract syntax, unique identifier (UID) information, etc.) of the DICOM file. The metadata may be followed by the pixel data. The pixel data may correspond to a single attribute/tag with tag ID “7FE0” that contains the pixel data corresponding to the image data. The pixel data may be stored as a series of 0s and 1s. In some embodiments, the pixel data in the DICOM file may begin at the tag with ID (7FE0, 0010). In some embodiments, for brevity, tags corresponding to the metadata may also be referred to as meta tags, and tags corresponding to the pixel data may also be referred to as pixel tags.

In some embodiments, the processing device 1400a may receive the request via/from one or more data stream (e.g., a network stream such as a socked network stream) (also referred to as first data stream(s)) that carries the request. The data stream may include instructions about how to process the DICOM file (e.g., what kind of service is requested) and/or data (e.g., the metadata, the pixel data, etc.) of the DICOM file. Taking the request and the data of the DICOM file included in a first data stream as an example, the first data stream may include multiple segments that are arranged/transmitted in sequence. Each of the multiple segments may have a limited size (e.g., a limited data length), which depends on the type of the first data stream. The multiple segments may include a first segment and one or more other segments arranged following the first segment. The first segment of the multiple segments may include a command set and a part of data (e.g., the metadata and/or a part of the pixel data) of the DICOM file. The command set may include instructions about how to process the DICOM file (e.g., to store, forward, etc., the DICOM file) and/or other meta information (e.g., the metadata or the file meta information) of the DICOM file. Following segments after the first segment of the multiple segments may include other parts of the DICOM file. For example, the pixel data may be divided into a plurality of segments according to a specific data length, and the following segments may include a section of the plurality of segments. More descriptions regarding the first data stream may be found elsewhere in the following disclosure (e.g., FIGS. 7-9 and relevant descriptions thereof).

In 1503, the processing device 1400a (e.g., the parsing module 1413) may parse at least part of the metadata of the DICOM file.

In some embodiments, the processing device 1400a may parse the at least part of the metadata of the DICOM file from the first data stream (e.g., from one or more segments of the first data stream). In some embodiments, the at least part of the metadata may include information regarding the size (e.g., the data length) of the pixel data of the DICOM file. The processing device 1400a may parse the size (e.g., the data length) of the pixel data of the DICOM file from the first data stream. In some embodiments, the processing device 1400a may parse information in the first data stream in sequence until the tag of (7FE0, 0010) of the DICOM file is detected. That is, the processing device 1400a may parse all information (e.g., the metadata of the DICOM file) before the pixel data of the DICOM file in the first data stream. For example, the processing device 1400a may parse all information before the tag of (7FE0, 0010) and parse information of 12 bytes which is subsequently after the tag of (7FE0, 0010) and describes the pixel data, and may not parse subsequent information after the information of 12 bytes. More descriptions regarding parsing the at least part of the metadata of the DICOM file may be found elsewhere in the following disclosure (e.g., FIGS. 7-9 and relevant descriptions thereof).

In some embodiments, the DICOM file may include multiple data elements. A data element is the smallest and indivisible data structure within a DICOM file that represents a single piece of information (also referred to as piece data). Pixel data may be a special data element. Each of the multiple data elements may include identification information (also referred to as information label) and an object described by the identification information, and the identification information may be also referred to as metadata of each data element. The identification information of a data element may include a tag, a value representation (VR), a value length (VL), etc. The object described by the identification information may be denoted by a value field (VF).

In some embodiments, parsing the at least part of the metadata of the DICOM file from the first data stream (e.g., from one or more segments of the first data stream) may include parsing metadata of each data element before the data element representing the pixel data (e.g., the tag of (7FE0, 0010)) from the first data stream.

In some embodiments, parsing the at least part of the metadata of the DICOM file from the first data stream (e.g., from one or more segments of the first data stream) may include parsing metadata of each data element before the data element representing the pixel data (e.g., the tag of (7FE0, 0010)) from the first data stream and the metadata of the data element representing the pixel data. The metadata of the DICOM file may include the metadata of data elements that do not representing the pixel data.

As a further example, After the processing device 1400a parses all information before the tag of (7FE0, 0010) of a data element representing the pixel data, the processing device 1400a may parse information which is subsequently after the tag of (7FE0, 0010) of the data element representing the pixel data. The information after the tag may include the VR and VL. The parsed data including the tag, VR, and VL may be used to combine the identification information (i.e., the metadata) of a data element with the object described by the identification information during the transmission of the DICOM file or combine the parsed data of the DICOM file and remaining data that is not parsed data to the DICOM file.

In some embodiments, in response to determining that the size of the pixel data exceeds a threshold, the metadata of a data element representing the pixel data of the DICOM file may be not parsed; in response to determining that the size of the pixel data does not exceed a threshold, the metadata of a data element representing the pixel data of the DICOM file may be parsed.

During the transmission of the DICOM file, the parsed metadata may be stored into a first storage device (e.g., the memory) of the processing device 1400 and the remaining data that is not parsed may be written into a data stream (e.g., a file stream to be stored into a second storage device (e.g., a hard disk) or into an outgoing network stream for sending to an external system through a gateway). The parsed metadata stored in the first storage device may be then written into the file stream where the remaining data that is not parsed to be stored into the second storage device or into the outgoing network stream for sending to the external system through the gateway. The parsed metadata written into the file stream where the remaining data that is not parsed to be stored into the second storage device or into the outgoing network stream for sending to the external system through the gateway may be combined with the remaining data that is not parsed to be stored to form the original DICOM. For example, for a data element, the metadata of the data element not representing the pixel data may be parsed to be stored in the first storage device and the object of the data element described by the metadata of the data element may be written into the data stream. The metadata of the data element and the object of the data element described by the metadata of the data element may be combined based on the parsed metadata of the data element to form a piece data. As a further example, the data element representing the pixel data that is not parsed may be written into the data stream and a data element that does not represent the pixel data and is parsed may be stored into the first storage device. When the data element that is parsed and stored into the first storage device is written in the data stream, the data element that is parsed may be combined with the data element representing the pixel data that is not parsed based on the parsed metadata to form the original DICOM file.

For example, as shown in FIG. 13A, in the C-store SCU, the DICOM file may be divided into multiple data segments and each of the multiple data segments may consist of a portion of the multiple data elements. Each of the multiple segments may also be referred to as a data packet. A P-DATA-TF protocol data unit header may be added to each data segment, which is an information label indicating the sequence and relationship of these data segments. Each of the data packets or segments may be sent by the C-store SCU to the C-store SCP according to the method as described elsewhere in the present disclosure. For example, the data A (i.e., metadata of data elements in each data packet) may be stored to the kernel buffer based on a memory mapping technique, a Hash table, etc., and read by the application running in the user space to the user buffer. The application may parse the data A to obtain the parsed metadata stored in the user buffer. The parsed metadata may be written into a data stream (e.g., a network stream) to be copied into the socket buffer by the application. The data B in each data packet may be written into the data stream stored in the socket buffer via a zero-copy technique. Then the data stream may be transmitted to the gateway directly. The data stream including the data A and data B may be a complete data packet to be transmitted to the C-store SCP.

As shown in FIG. 13B, the C-store SCP may receive the data packet from the C-store SCU through the gateway, combine the multiple data packets to form the DICOM file, and write the DICOM file into a hard disk or an outgoing network stream. For example, the data A (i.e., the metadata of data elements in each data packet) may be copied to the socket buffer based on a memory mapping technique, a Hash table, etc. and then may be transmitted to the user buffer in the user space. The application may parse the data A to obtain the parsed metadata stored in the user buffer. The parsed metadata may be written into a data stream (e.g., a file stream) to be copied into the kernel buffer by the application. The data B in each data packet may be written into the data stream directly based on a zero-copy technique based on the passed metadata directly to form a complete data packet based on the parsed metadata (e.g., the tag, VR, VL, and VF). The data packet then may be stored into the hard disk or an external storage device.

In some embodiments, the processing device 1400a may parse the at least part of the metadata of the DICOM file based on a default model. The default model may be determined based on structure characteristics of a DICOM file. For example, the structure characteristics may include a binary structure of a data element, a data dictionary including standard information of all tags, a transfer syntax, or the like, or a combination thereof.

In 1505, the processing device 1400a (e.g., the parsing module 1413, the rewriting module 1415, etc.) may write data of the DICOM file to one or more data streams (also referred to as second data stream(s)) based on the parsed metadata.

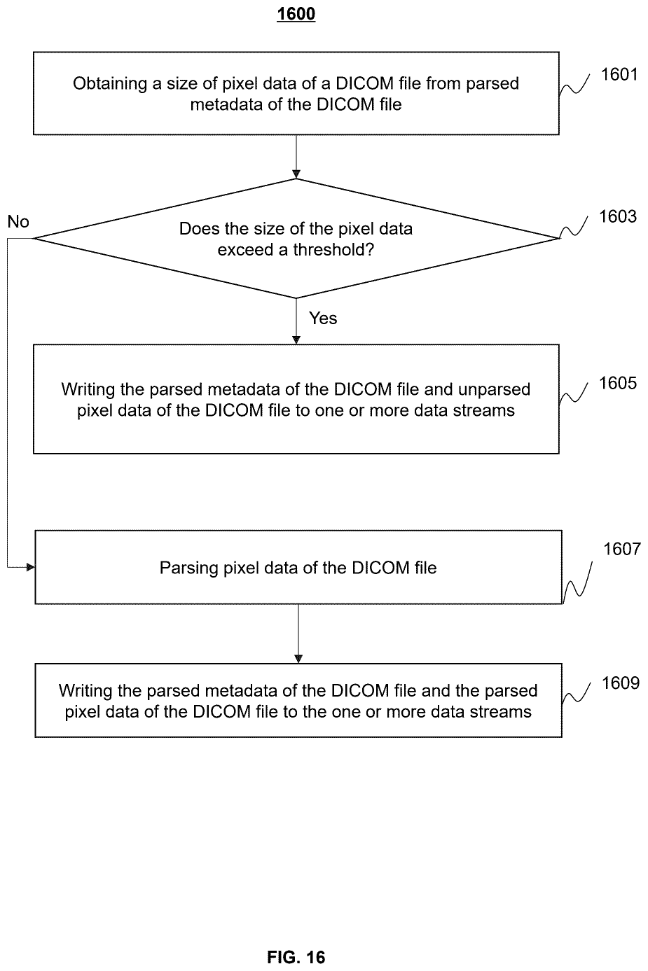

In some embodiments, at least part of the data of the DICOM file written to the second data stream may be not parsed. For example, the processing device 1400a may obtain the size (e.g., the data length) of the pixel data from the parsed metadata. The processing device 1400a may write the data of the DICOM file to the second data stream based on whether the size (e.g., the data length) of the pixel data exceeds a threshold (e.g., a threshold length). For instance, in response to determining that the data length of the pixel data does not exceed the threshold length, the processing device 1400a may parse the pixel data of the DICOM file. The processing device 1400a may write the parsed metadata of the DICOM file and the parsed pixel data of the DICOM file to the second data stream. In response to determining that the data length of the pixel data exceeds the threshold length, the processing device 1400a may not parse the pixel data of the DICOM file and directly write the parsed metadata of the DICOM file and the unparsed pixel data of the DICOM file to the second data stream(s). Alternatively, in response to determining that the data length of the pixel data exceeds the threshold length, the processing device 1400a may parse the pixel data of the DICOM file. The processing device 1400a may write the parsed metadata and the parsed pixel data to the second data stream(s).More descriptions regarding writing the data of the DICOM file to the second data stream(s) based on the parsed metadata may be found elsewhere in the following disclosure (e.g., FIG. 16 and relevant descriptions thereof).

In some embodiments, according to different types of how to process the DICOM file, the second data stream may have different types. For example, if the DICOM file is requested to be stored in the image file system (e.g., a local file system), the second data stream may include a file stream, such that the data of the DICOM file written to the second data stream can be stored in a storage device (e.g., the storage 140 or a disk such as a hard disk) of the local file system. As another example, if the DICOM file is requested to be forwarded to an external system via the image file system, the second data stream may include a network stream (e.g., a socket network stream), such that the data of the DICM written to the second data stream can be transferred or forwarded to the external system via a network (e.g., the network 1250). More descriptions regarding the different types of the second data stream may be found elsewhere in the following disclosure (e.g., FIGS. 17-20 and relevant descriptions thereof).

In some embodiments, before operation 1505, the processing device 1400a may determine whether the DICOM file is a DICOM sub-file. As used herein, a DICOM sub-file refers to a file in a DICOM format that is generated based on a part of pixel data of a specific DICOM file. Such DICOM sub-file may include a private tag in metadata of the DICOM sub-file for labeling the DICOM sub-file, e.g., indicating the type of the DICOM sub-file, a sequence number of the DICOM sub-file in its corresponding specific DICOM file, a total count (or number) of DICOM sub-files corresponding to the specific DICOM file, the name of the DICOM sub-file, the size (e.g., the data length) of the DICOM sub-file, or the like, or any combination thereof. For example, the processing device 1400a may determine whether the DICOM file carried by the first data stream is a DICOM sub-file based on the parsed metadata of the DICOM file. In response to determining that the DICOM file carried by the first data stream is a DICOM sub-file, the processing device 1400a may create a document folder in the disk of the image file system and store data of the DICOM sub-files corresponding to the specific DICOM file in the document folder until the last DOCOM sub-file of the DICOM sub-files corresponding to the specific DICOM file is received. In some embodiments, the processing device 1400a may restore the specific DICOM file by combining the DICOM sub-files based on sequence numbers of the DICOM sub-files stored in the document folder.

In some embodiments, different from operation 1501, the processing device 1400a may directly obtain/receive the DICOM file according to the DICOM protocol. The processing device 1400a may obtain the pixel data of the DICOM file. The processing device 1400a may segment the pixel data of the DICOM file to a plurality of pixel groups, more descriptions of which may be similar to the segmenting parsed pixel data to a plurality of pixel groups as described in operation 608 in FIG. 16. The processing device 1400a may generate a plurality of DICOM sub-files based on the plurality of pixel groups respectively, more descriptions of which may be found elsewhere in the present disclosure (e.g., FIGS. 21-25 and relevant descriptions thereof). Each of the plurality of DICOM sub-files may satisfy the DICOM standard and in the DICOM format. Further, the processing device 1400a may transfer the plurality of DICOM sub-files in a parallel fashion. For instance, the processing device 1400a may write data of the plurality of DICOM sub-files to one or more data streams (e.g., the second data stream(s)). The processing device 1400a may transfer the one or more second data streams in a parallel fashion for achieving transferring the DICOM file. Merely by way of example, data of each of the plurality of DICOM sub-files may be written to one of the second data stream(s). The second data streams(s) each of which carries the data of each of the plurality of DICOM sub-files may be transferred in a parallel fashion. Alternatively, the plurality of DICOM sub-files may be transferred according to the DICOM protocol in a parallel fashion. In some embodiments, before segmenting the pixel data of the DICOM file, the processing device 1400a may determine a size (e.g., a data length) of the pixel data based on the metadata of the DICOM file. The processing device 1400a may determine whether the size (e.g., the data length) exceeds a threshold (e.g., a threshold length). In response to determining that the data length of the pixel data exceeds the threshold length, the processing device 1400a may perform the segmentation operation on the pixel data of the DICOM file. More descriptions regarding the determining whether the size (e.g., the data length) of the pixel data exceeds the threshold (e.g., the threshold length) may be similar to that described in operation 1603 in FIG. 16, which is not repeated herein.

It should be noted that the above description regarding the process 1500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added to or omitted from the process 1500. For example, the process 1500 may include an additional operation for causing the image file system to archive the DICOM file. As another example, a storing operation may be added elsewhere in the process 1500. In the storing operation, the processing device 1400a may store information and/or data used or obtained disclosed elsewhere in the present disclosure. In some embodiments, an operation of the process 1500 may be divided into at least two sub-operations. For example, operation 1505 may be divided into two sub-operations, one of which is for determining whether the data length of the pixel data of the DICOM file exceeds the threshold length and another one of which is for writing the data of the DICOM file based on the determination results. In some embodiments, the request for processing the DICOM file may include only how to process the DICOM file without the DICOM file, and the DICOM file may be pre-stored in the image file system. For example, the processing device 1400a may receive a request for querying and/or retrieving the DICOM file from the image file system. The request may include the file meta information contained in the group “0002” of the DICOM file to be queried and/or retrieved. The processing device 1400a may parse the request to obtain the file meta information of the DICOM file. The processing device 1400a may determine where the DICOM file is stored and write data of the DICOM file from the image file system (e.g., from a file stream containing the data of the DICOM file) to the second data stream (e.g., a network data stream such as a socked stream). The processing device 1400a may transmit the DICOM file to a client end (e.g., the terminal 1240) that requests to query and/or retrieve the DICOM file for further processing.

FIG. 16 is a flowchart illustrating an exemplary process for DICOM file processing according to some embodiments of the present disclosure. In some embodiments, the process 1600 may be implemented as a set of instructions (e.g., an application) stored in a storage device (e.g., the storage device 1230, the storage device 220, and/or the storage 390). The processing device 1220 (e.g., the processor 210, the CPU 340, and/or one or more modules illustrated in FIG. 14A) may execute the set of instructions, and when executing the instructions, the processing device 1400a may be configured to perform the process 1600. The operations of the illustrated process presented below are intended to be illustrative. In some embodiments, the process 1600 may be accomplished with one or more additional operations not described and/or without one or more of the operations discussed. Additionally, the order of the operations of process 1600 illustrated in FIG. 16 and described below is not intended to be limiting. In some embodiments, operation 1505 in FIG. 15 may be achieved by the process 1600.

In 1601, the processing device 1400a (e.g., the rewriting module 1415) may obtain a size (e.g., a data length) of pixel data of a DICOM file from parsed metadata of the DICOM file

As described in connection with operations 1501 and 1503, the metadata of the DICOM file may store the size (e.g., the data length) of the pixel data of the DICOM file. The processing device 1400a may directly obtain the size (e.g., the data length) of the pixel data of the DICOM file after parsing at least part of the metadata of the DICOM file from the first data stream.

In 1603, the processing device 1400a (e.g., the rewriting module 1415) may determine whether the size (e.g., the data length) of the pixel data exceeds a threshold (also referred to as a first threshold) (e.g., a first threshold length).

In some embodiments, in response to determining that the size (e.g., the data length) of the pixel data exceeds the first threshold (e.g., the first threshold length), the process 1500 may proceed to operation 1605. In response to determining that the data length of the pixel data does not exceed the threshold length, the process 1500 may proceed to operation 1607.

In some embodiments, the first threshold (e.g., the first threshold length) may be determined at least based on the size of cache of the system (e.g., the image file system) executing the process 1500 and/or 1600. For example, the image file system (e.g., a local file system such as the PACS) may have a cache (or buffer) of a certain size. The first threshold may be determined to be equal to or less than the certain size of the cache, such that parsed pixel data of the DICOM file can be temporarily stored in a buffer and then be transferred to the disk (e.g., a hardware disk) of the image file system. In some embodiments, the first threshold may be determined based on a read-write speed of the disk of the image file system and/or a transfer speed of the first data stream that carries the DICOM file, as well as the size of cache. For example, the greater the size of cache, the greater the first threshold may be determined. As another example, the faster the read-write speed of the disk is, the greater the first threshold may be determined. As another example, if the read-write speed of the disk is slower than the transfer speed of the first data stream, the greater a difference between the read-write speed of the disk and the transfer speed of the first data stream, the less the first threshold may be determined. In some embodiments, the first threshold may be determined based on statistics of historical data received by the image file system. For example, the first threshold may be determined based on user experience regarding the historical data. As another example, the first threshold may be determined by machine learning based on historical data. For instance, a machine learning model may be trained based on the historical data. An input of the machine learning model may include parameters of the data length of the pixel data of the DICOM file, the read-write speed of the disk, the transfer speed of the first data stream, the size of cache, etc., and an output of the machine learning model may be the first threshold. In some embodiments, the first threshold may be adjustable in real time.

In 1605, in response to determining that the data length of the pixel data exceeds the threshold (i.e., the first threshold), the processing device 1400a (e.g., the rewriting module 1415) may write the parsed metadata of the DICOM file and pixel data of the DICOM file to one or more data streams (i.e., the second data stream(s) described in FIG. 15).

In some embodiments, the processing device 1400a may directly obtain the pixel data of the DICOM file from the first data stream without parsing, i.e., the pixel data of the DICOM file is not parsed. The processing device 1400a may write the parsed metadata and the unparsed pixel data to the second data stream.

In some embodiments, the processing device 1400a may parse a part of the pixel data of the DICOM file and write the parsed pixel data and unparsed pixel data of the DICOM file to the second data stream. For instance, in response to determining that the size (e.g., the data length which is denoted by D) of the pixel data exceeds the first threshold (e.g., the first threshold length), the processing device 1400a may parse the part of the pixel data from the first data stream based on a second threshold (e.g., a second threshold length). For example, the second threshold (e.g., the second threshold length) may be a threshold with a fixed data length, which may be determined based on the size of memory of the image file system that receives the DICOM file. The processing device 1400a may parse a part of the pixel data of the DICOM file a data length of which is equal to the second threshold length and do not parse remaining pixel data of the DICOM file in the first data stream. As another example, the second threshold length may be a dynamic threshold that is equal to a certain percentage (e.g., denoted by P such as 1%, 5%, 10%, 20%, etc.) multiplying the data length of the pixel data of the DICOM file. The processing device 1400a may parse a part of the pixel data of the DICOM file a data length of which is equal to the certain percentage multiplying the data length of the pixel data of the DICOM file (i.e., A*D) and not parse remaining pixel data of the DICOM file a data length of which is equal to (1−A)*D.

In 1607, in response to determining that the data length of the pixel data does not exceed the threshold length, the processing device 1400a (e.g., the rewriting module 1415) may parse the pixel data of the DICOM file. In some embodiments, the processing device 1400a may parse the pixel data of the DICOM file by parsing information from and after the tag with an ID of (7FE0, 0010) in the first data stream(s).

In 608, the processing device 1400a (e.g., the rewriting module 1415) may write the parsed metadata of the DICOM file and the parsed pixel data of the DICOM file to the one or more data streams (i.e., the second data stream(s)).

In some embodiments, the processing device 1220 may directly write the parsed metadata of the DICOM file and the parsed pixel data of the DICOM file to the second data stream. Alternatively, the processing device 1400a may segment the parsed pixel data into a plurality of pixel groups. Each of the plurality of pixel groups may carry a sequence number that indicates a segmentation order of the pixel group in the parsed pixel data. For example, the processing device 1400a may obtain an optimal size (e.g., an optimal data length) for segmentation. The processing device 1220 may segment the parsed pixel data into the plurality of pixel groups based on the optimal size (e.g., the optimal data length). For instance, a data length of one of the plurality of pixel groups may be equal to the optimal data length. In some embodiments, the optimal size (e.g., the optimal data length) may be adjustable in real time or a default setting of the PACS (e.g., which is determined based on user experiences). For example, the optimal size (e.g., the optimal data length) may be determined based on the size of ache or buffer of the PACS. As another example, the optimal size (e.g., the optimal data length) may be determined based on the transfer speed of the second data stream(s). Further, the processing device 1400a may write the plurality of pixel groups to the second data stream(s). For example, the processing device 1400a may write one or more of the plurality of pixel groups to one of the second data stream(s). The processing device 1400a may transfer the one or more second data stream(s) in a parallel fashion.

It should be noted that the above description regarding the process 1600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added to or omitted from the process 1600. In some embodiments, an operation of the process 1600 may be divided into two or more sub-operations. In 608, for the plurality of pixel groups, the processing device 1400a may not generate the plurality of DICOM streams. The processing device 1400a may directly store the plurality of pixel groups in ache or buffer of the PACS and then transfer the plurality of pixel groups from ache to the second data stream.

FIG. 17 is a schematic diagram illustrating an exemplary process for DICOM file processing according to some embodiments of the present disclosure. In some embodiments, the process 1700 may be implemented as a set of instructions (e.g., an application) stored in a storage device (e.g., the storage device 1230, the storage device 220, and/or the storage 390). The processing device 1400b (e.g., the processor 210, the CPU 340, and/or one or more modules illustrated in FIG. 14B) may execute the set of instructions, and when executing the instructions, the processing device 1400b may be configured to perform the process 1700. The operations of the illustrated process presented below are intended to be illustrative. In some embodiments, the process 1700 may be accomplished with one or more additional operations not described and/or without one or more of the operations discussed. Additionally, the order of the operations of process 1700 as illustrated in FIG. 17 and described below is not intended to be limiting. In some embodiments, the process 1700 may be implemented by the processing device 1400a. Alternatively, the process 1700 may be implemented by a server end such as an image file system (e.g., a local file system such as the PACS or the C-Store SCP thereof) of the file transmission system 1200. For example, the processing device 1400b may be a part of the server end (e.g., the image file system).

In 1701, the processing device 1400b (e.g., the receiving module 1421) may receive a request for processing a DICOM file. The request may include a service type that is to be requested.

In some embodiments, the request may be sent by a client end (also referred to as an opposite end) (e.g., the terminal 1240). The client end may send the request in a format of a processing stream (e.g., a network stream such as a socket stream). The processing stream may include a command set and data sets that are generated based on a DCIOM protocol format. The data sets may be the first processing stream in 1703. According to the command set, the processing device 1400b may obtain the service type of the request for further providing corresponding processing (e.g., the subsequent parsing processing). The service type may include a plurality of types according to actual needs, e.g., a querying service, a storage service, an obtaining service, a sending/forwarding service, a deletion service, etc., which is not limited herein.

In some embodiments, before operation 1701, the client end and the server end (e.g., the processing device 1400b) may establish a network connection. The present disclosure may not limit the mode of how to establish the network connection. For example, the processing device 1400b may receive a request for establishing a network connection from the client end. The processing device 1400b may determine a service type that the client end is requested according to the request for establishing a network connection. The processing device 1400b may determine whether the service type is supported locally (e.g., whether the service type is supported by the server client). In response to determining that the service type is supported locally, the processing device 120b may feed a confirmation massage back to the client end and establish the network connection with the client end. It should be noted that in response to determining that the service type is not supported locally, the processing device 120b may feed a rejection message back to the client end and not establish the network connection with the client end. In some embodiments, the processing device 1400b may be configured with different operating environments in advance to support different service types.

In 1703, the processing device 1400b (e.g., the obtaining module 1423) may obtain a first processing stream (also referred to as a first processing flow). The first processing stream may be the same as or similar to the first data stream(s) as described in operation 1501 in FIG. 15.

In some embodiments, the first processing stream may be sent by the client end. The first processing stream may include medical image data (e.g., pixel data) of the DICOM file.

In 1705, the processing device 1400b (e.g., the parsing module 1425) may parse header data of the DICOM file from the first processing stream. The header data of the DICOM file may be the same as or similar to the metadata of the DICOM file as described in operation 1501 in FIG. 15.

In some embodiments, the processing device 1400b may parse the header data in the first processing stream based on the format specification of the DICOM protocol. The header data and medical image data in the first processing stream may be distinguished based on an end mark (e.g., a tag ID), so that the header data in the first processing stream may be parsed based on the end mark. For example, the tag ID of (7FE0,0010) may be used as an end mark. Data before the end mark may be the header data, and data after the end mark may be the medical image data. That is, the header data is followed by the medical image data. During an actual implementation process, the processing device 1400b may parse data from the beginning of the first processing stream until the end mark. In some embodiments, the processing device 1220 may store the parsed header data in a memory (e.g., a memory of the server end (e.g., a memory of the image file system)). In some embodiments, the header data may usually be 12 bytes and mainly includes file meta information of the DICOM file (i.e., meta tags). The meta tag may define transfer syntax, record a data length of the medical image data in the DICOM file, etc.

In 1707, the processing device 1400b (e.g., the first writing module 1427) may write the parsed header data and unparsed pixel data of the DICOM file to a second processing stream. The second processing stream may be the same as or similar to the second data stream(s) as described in operation 1503 in FIG. 15.

In some embodiments, as described in operation 1705, the parsed header data may be stored in the memory of the server end. The processing device 1400b may write the parsed header data from the memory to the second processing stream. At the same time, the processing device 1400b may write the unparsed medical image data to the second processing stream. In some embodiments, data sources of the unparsed medical image data written to the second processing stream may be from the first processing stream or be locally sourced, which is not limited herein. For example, the processing device 1400b may write the unparsed medical image data to the second processing stream from the first processing stream or a local storage device (e.g., a disk or the memory of the image file system).

In some embodiments, the type of the second processing stream and the mode for processing the second processing stream (e.g., how to process the second processing stream) may correspond to the service type of the request. For example, the service type may be the storage service. Correspondingly, the first processing stream may be a network stream sent by the client end, and the second processing stream may be a local file stream. The application scenario of the storage service is mainly that the client end sends a DICOM file to the server end, and the server end receives, stores, and/or achieves the DICOM file. For example, the client end that supports the DICOM protocol may send the DICOM file to the server end through the C-Store. In such cases, the first processing stream may be the network stream sent by the client end. For example, the network stream may include a socket network stream. The present disclosure may not limit a specific transmission protocol used by the network stream. The second processing stream may be the local file stream, via which a local placement of the DICOM file can be achieved (e.g., the DICOM file is stored in the disk locally).

For illustration purposes, an exemplary process for achieving a storage service may be illustrated in FIG. 18. The process in FIG. 18 may include operations 1801-1806 and involve two implementation subjects (e.g., a client end (e.g., SCU) 1810 and a server end (e.g., SCP) 1820).

In 1801, the client end 1810 may send a request of A-SSOCIATE-RQ for establishing a network connection to the server end 1820. Since there may be various service requests, only when the server end 1820 supports the service type, the server end 1820 may feed a confirmation message of A-SSOCIATE-AC back to the client end 1810. In such cases, a network connection may be established between the server end 1820 and the client end 1810. If the service type requested by the client end 1810 is not supported by the server end 1820, the server end 1820 may feed a rejection message of A-SSOCIATE-RJ back to the client end 1810.

In 1802, the client end 1810 may receive the ASSOCIATE-AC returned by the server end 1820, which indicates that the network connection has been established between the client end 1810 and the server end 1820.

In 1803, the client end 1810 may send a processing stream of P-DATA-TF (RQ) to the server end 1820. The P-DATA-TF (RQ) may carry a command set and data sets. For example, the P-DATA-TF (RQ) may be the socket network stream. The server end 1820 may monitor and receive the socket network stream through a socket port. It should be noted that the socket network stream may be composed of sections of data, that is, various segments. Each of the various segments may have a limited maximum data length. In the socket network stream, the command set may be followed by the data sets. A first segment of the various segments may include the command set and a part of the data sets, and following segments of the various segments may include remaining of the data sets.

In some embodiments, the client end 1810 may send the processing stream of P-Data-TF (RQ) to the server end 1820 according to an instruction of the column storage database. The column storage database may include the C-Store, which is not limited herein. The C-Store is a relational database designed for a quick query. To achieve a quicker query performance, the C-Store stores data according to columns. Different columns in the same table may be stored in different projections, and the projections may have overlapping parts. The projection used herein refers to a set of data storage columns.

In some embodiments, after receiving the P-Data-TF (RQ), the server end 1820 may parse the command set in the P-Data-TF (RQ) to determine the service type required by the client end 1810, so as to use/initiate a specific service to process the data sets carried subsequently in the P-Data-TF (e.g., to process the first processing stream). In related technologies, the processing mode may need to write all the received data sets to the memory, which may result in too much consumption of memory resources. Alternatively, the data may be directly written into the local cache, and retrieved from the cache when subsequent use, which may result in a sharp increase of I/O (Input/Output) operations, thereby reducing system processing performance.

To avoid or reduce the above two situations, the present disclosure mainly analyzes, based on the DICOM standard for the DICOM file format, features of data elements and their components in the data sets of the DICOM file, so as to perform de-memory and de-cache processing on the medical image data. That is, the present disclosure may bypass the memory and/or cache, and directly establish a pipeline connection with the real destination (e.g., a target receiving end) of the DICOM file, thereby achieving quick and efficient processing of the medical image data.

In some embodiments, the server end 1820 may obtain data sets in the P-Data-TF (RQ) (i.e., the data part (the first processing stream) in the socket network stream) to parse the header data in the first processing stream. It should be noted that the server end 1820 in FIG. 18 provides the storage service. In the actual implementation process, the server end 1820 may monitor obtained network data (i.e., the socket network stream) to dynamically obtain data needed. For example, the server end 1820 may obtain the command set and the first processing stream by adopting the dynamic obtaining mode. As the obtaining of the network data is an I/O operation, a blocking I/O mechanism and a non-blocking I/O mechanism may be adopted to obtain the network data. Further, a synchronous I/O mechanism and an asynchronous I/O mechanism may be adopted to obtain the network data.

As used herein, the concepts of blocking I/O and non-blocking I/O are program-levels, which are used to describe the problem that after the program requests to operate system I/O operation, if the I/O resource is not prepared, what should the program do. For example, if the I/O resource is not prepared, the blocking I/O mechanism may wait, while the non-blocking I/O mechanism may keep performing, that is, the thread would always be inquired until the I/O resource is ready.

As used herein, the concepts of synchronous I/O and asynchronous I/O are operating system levels, which are used to describe the problem that, after the operating system receives the program request for the I/O operation, if the I/O resource is not prepared, how to respond to the program. For example, if the I/O resource is not prepared, the synchronous I/O may not respond until the I/O resource is ready, while the asynchronous I/O may feed a tag back to mark a return target after the event that the I/O resource is ready. Through the different I/O mechanisms, the server end 1820 may parse the first processing stream section by section. For example, only the header data in the first processing stream may be parsed. The header data may usually be 12 bytes and not exceed 16 Kb. In some embodiments, the header data may be cut out from the first processing stream through an end mark (e.g., the tag ID (7fe0,0010)), and the parsed header data may be recorded and saved.

In some embodiments, the server end 1820 may write the parsed header data to the second processing stream, that is, to the local file stream of the server end 1820. At the same time, the unparsed medical image data in the first processing stream may be written into the second processing stream. Finally, the DICOM file may be placed/stored locally through the second processing stream. At this point, the storage service provided by the server end 1820 may end.

In 1804, the server end 1820 may selectively feed the P-Data-TF (RSP) back to the client end 1810 to indicate the end of the storage service as a response.

In 1805, after the client end 1810 receives the P-Data-TF (RSP), the client end 1810 may send a request of A-Release-RQ for releasing the network connection to the server end 1820. In 1806, after receiving the A-Release-RQ, the server end 1820 may feed A-Release-RP back to the client end 1810 to indicate the confirmation of releasing the network connection with the client end 1810.

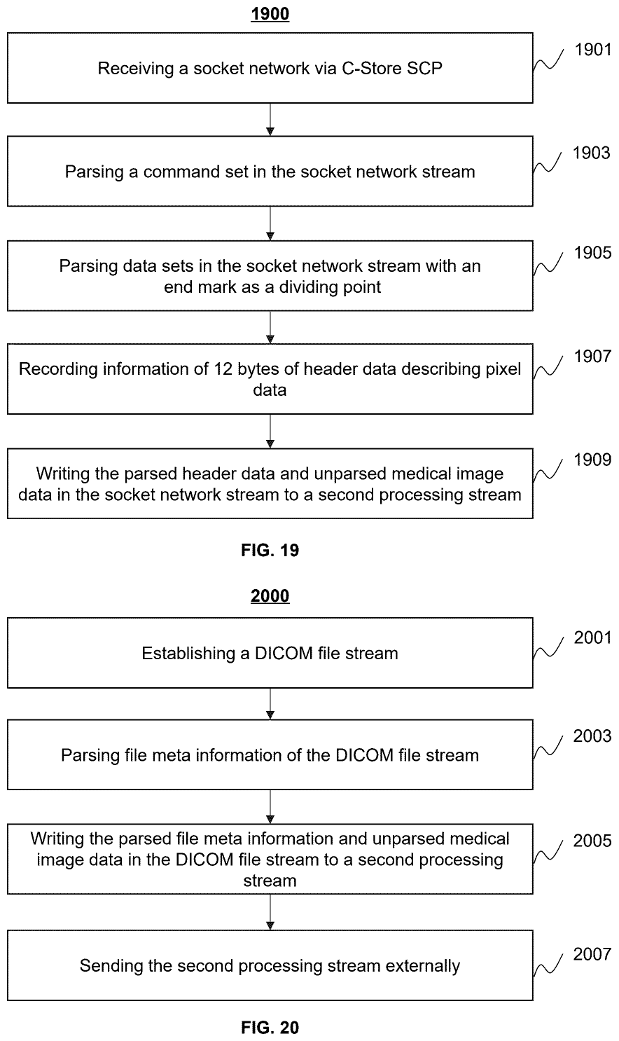

The above descriptions may be the exemplary process when the service type is the storage service, the brief process of which may be illustrated in FIG. 19. The process of 1900 may include operations 1901-1909 as follows, which may be implemented by the processing device 1400b or the server end (e.g., the server end 1820).

In 1901, a socket network stream may be received through C-Store SCP.

In 1903, a command set may be parsed in the socket network stream.

In 1905, data sets in the socket network may be parsed with an end mark as a dividing point.

In 1907, information of 12 bytes of header data describing pixel data (e.g., header data describing medical image data in the socket network stream) may be recorded.

In 1909, the parsed header data and unparsed medical image data in the socket network stream may be written to a second processing stream.

According to the process 1700, 800, or 1900 of the present disclosure, there is no need to write all received data sets into the memory of the image file system, thereby avoiding or reducing the excessive consumption of memory resources. At the same time, there is no need to write all received data sets into the local cache, and then retrieve them from the local cache, thereby avoiding the sharp increase of I/O operations that reduces the system processing performance.

In some embodiments, the header data may include the recorded data length of the unparsed medical image data. Correspondingly, before processing the second processing stream, the processing device 1400b may determine an actual data length of the unparsed medical image data. If the recorded data length is consistent with the actual data length, the processing device 1400b may obtain the unparsed medical image data from the first processing stream, and write the unparsed medical image data to the second processing stream.

As described elsewhere in the present disclosure, the header data and the medical image data in the first processing stream are mainly distinguished by the end mark. In the embodiments, the processing device 1400b may start statistics from the end mark until the end of the medical image data in the first processing stream, so as to determine the actual data length of the unparsed medical image data. The end of the medical image data in the first processing stream may be a preset end mark (e.g., a preset character or a preset fixed byte), which is not limited herein.

When the service type is the storage service, the data source of the unparsed medical image data may be the first processing stream, so that the unparsed medical image data may need to be obtained from the first processing stream. In such cases, the recorded data length may be compared with the actual data length. If the recorded data length is inconsistent with the actual data length, the unparsed medical image data may not be obtained from the first processing stream. In such cases, a resend message may be fed back to the client end (e.g., the client end 1810), so that the client end may resend the first processing stream. If the recorded data length is consistent with the actual data length, the unparsed medical image data may be obtained from the first processing stream, and the unparsed medical image data may be written to the second processing stream without passing the memory or the local cache of the image file system.

According to some embodiments of the present disclosure, by determining the actual data length of the unparsed medical image data, if the recorded data length is consistent with the actual data length, the processing device 120b may obtain the unparsed medical image data from the first processing stream, and write the unparsed medical image to the second processing stream. The determination result of whether the actual data length and the recorded data length of the medical image data are consistent (or equivalent) may be used to indicate whether there is an error in the medical image data, thereby avoiding the situation of writing wrong medical image data to the second processing stream, and ensuring the accuracy of the data in the subsequent local placement.

In some embodiments, the service type may be a forwarding service. Correspondingly, the first processing stream may be a network stream sent by the client end (e.g., the client end 1810), and the second processing stream may be a network stream that is forwarded externally (e.g., forwarded to the client end).

An application scenario of the forwarding service may be that a client end (e.g., the client end 1810) sends the DICOM file to a server (e.g., the server end 1820) and the server end may forward the DICOM file to other client ends or other server ends. In some embodiments, the client end that supports the DICOM protocol may send the DICOM file to the server end through C-Store. In such cases, the first processing stream refers to the network stream sent by the client end to the server end. The network stream may include a socket network stream. The present disclosure may not limit the transmission protocol used by the network stream. The second processing stream may be a network stream that the server end forwarded externally, through which the DICOM file may be forwarded to other client ends or server ends. In such cases, there is no need to write all received data sets to the memory of the image file system, so as to avoid excessive consumption of the memory resource. Alternatively, there is no need to write all received data sets into the local cache of the image file system, and then retrieve them from the local cache, thereby avoiding the sharp increase of I/O operations which may reduce the system processing performance.

In some embodiments, before processing the second processing stream, if there is locally stored medical image data that is the same as the unparsed medical image data, the processing device 1400b may write the locally stored medical image data to the second processing stream. Alternatively, if there is no locally stored medical image data that is the same as the unparsed medical image data, the processing device 1400b may obtain the unparsed medical image data from the first processing stream and write the unparsed medical image data to the second processing stream.

It can be seen from the above embodiments that when the service type is the forwarding service, that is, the terminal end sends the DICOM file to the server end, and the server end forwards the DICOM file to other client ends or server ends, the server end may not pre-store the DICOM file in advance or have stored the DICOM file. Therefore, different processes may be provided for different situations. Whether there is locally stored medical image data that is the same as the unparsed medical image data may be determined based on the parsed header data. For example, the parsed header data may include a unique identifier used to correspond with the medical image data, such as tag information (e.g., one or more tags), including an image width and height, a data transmission format, a patient name, a patient birthday, a medical record hospital, a medical record department, the description of a disease, etc. For a certain medical image data, to determine whether the medical image data has been stored locally, whether the tag information of the medical image data has been stored locally may be searched. If the tag information of the medical image data has been stored locally, the medical image data may be indicated to have been stored locally. If the tag information of the medical image data has not been stored locally, the medical image data may be indicated to be not stored locally.

To facilitate understanding, the implementation process of the forwarding service may also be described in connection with FIG. 18.

In 1801, the client end 1810 may send a network connection request A-SSOCIATE-RQ to the server end 1820. Since there may be various service types requested, only when the service type is supported by the server end 1820, the server end 1820 may selectively feed a confirmation message of A-SSOCIATE-AC back to the client end 1810. In such cases, a network connection may be established between the server end 1820 and the client end 1810. If the service type is not supported by the server end 1820, the server end 1820 may feed a rejection message of A-SSOCIATE-RJ back to the client end 1810.

In 1802, the client end 1810 may receive the ASSOCIATE-AC returned by the server end 1820, which indicates the network connection has been established between the client end 1810 and the server.

In 1803, the client end 1810 may send a processing stream of P-Data-TF (RQ) that carries a command set and data sets to the server end 1820. The P-Data-TF (RQ) may be a socket network stream. The server end 1820 may monitor through a socket port to receive the socked network stream. It should be noted that the socket network stream may be composed of sections of data, that is, various segments. Each of the various segments may have a maximum data length. In the socket network stream, the command set may be followed by the data sets. A first segment of the various segments may include the command set and a part of the data sets, and the following segments of the various segments may include the remaining of the data sets. In some embodiments, the client end 1810 may send the P-Data-TF (RQ) to the server end 1820 according to an instruction of C-Store.

In some embodiments, after receiving the P-Data-TF (RQ), the server end 1820 may parse the command set in the P-Data-TF (RQ) to determine the service type required by the client end 1810, so as to use/initiate a specific service to process the data sets carried by subsequently in the P-Data-TF (i.e., to process the first processing stream). In related technologies, the processing mode may include writing all the received data sets to the memory, which may result in too much consumption of memory resources. Alternatively, the data may be directly written into the local cache, and retrieved from the cache when subsequent use, which may result in a sharp increase of I/O operations, thereby reducing system processing performance.

To avoid or reduce the above two situations, the present disclosure mainly analyzes, based on the DICOM standard for the DICOM file format, the features of data elements and their components in the data sets of the DICOM file, so as to perform de-memory and de-cache processing on the medical image data. That is, the present disclosure may bypass the memory and/or cache, and directly establish a pipeline connection with the real destination of the DICOM file, thereby achieving quick and efficient processing of the medical image data.

In some embodiments, the data sets in P-Data-TF (RQ) (i.e., the data part of the socket network stream) may be the first processing stream. As the unparsed medical image data in the first processing stream may have been stored or not stored, the server end 1820 may determine whether there is locally stored medical image data that is the same as the unparsed medical image data based on the parsed header data.

In some embodiments, the medical image data may be verified by a verification code, and each medical image data may correspond to a unique verification code (e.g., a UID (such as an SOP Instance UID) of the DICOM file corresponding to the medical image data). Different DICOM files corresponding to different medical image data may correspond to different SOP instance UIDs. The present disclosure may not limit the modes of how to determine whether there is locally stored medical image data that is the same as the unparsed medical image data based on the parsed header data. For example, the server end 1820 may obtain the verification code corresponding to the unparsed medical image data. The server end 1820 may compare the verification code corresponding to the unparsed medical image data with a verification code corresponding to locally stored medical image data. If there is the same verification code as the verification code corresponding to the unparsed medical image data, the server end 1820 may determine that there is locally stored medical image data that is the same as the unparsed medical image data. If there is no same verification code as the verification code corresponding to the unparsed medical image data, the server end 1820 may determine there is no locally stored medical image data that is the same as the unparsed medical image data.

If the server end 1820 determines that there is locally stored medical image data that is the same as the unparsed medical image data, the server end 1820 may write the parsed header data and the locally stored medical image data which is the same as unparsed medical image data to the second processing stream (i.e., the network stream that is forwarded externally). If the server end 1820 determines that there is no locally stored medical image data that is the same as the unparsed medical image data, the server end 1820 may write the parsed header data and the unparsed medical image data in the first processing stream to the second processing stream (i.e., the network stream that is forwarded externally). Accordingly, the DICOM file may be implemented to be forwarded externally through the second processing stream.

At this point, the storage service provided by the server end 1820 may end. In 1804, the server end 1820 may selectively feed the P-Data-TF (RSP) back to the client end 1810 to indicate the end of the storage service as a response. In 1805, after the client end 1810 receives the P-Data-TF (RSP), the client end 1810 may send a request of A-Release-RQ for releasing the network connection to the server end 1820. In 1806, after receiving the A-Release-RQ, the server end 1820 may feed the A-Release-RP back to the client end 1810 to indicate the confirmation of releasing the network connection with the client end 1810. It should further be noted that the operation 1806 only represents the end of the data transmission between the client end 1810 and the server end 1820. The server end 1820 may need to forward the DICOM file to other terminals or other servers. For example, the server end 1820 may further need to establish a network connection with the real destination (e.g., the other terminals or servers), which is similar to the data transmission between the client end 1810 and the server end 1820, which is not repeated here.

The above descriptions may be the exemplary process when the service type is the forwarding service. Taking that there is locally stored medical image data that is the same as the unparsed medical image data as an example, a brief process of the forwarding server may further be illustrated in FIG. 20. The process of 2000 may include operations 2001-2007 as follows, which may be implemented by the processing device 1400b or the server end (e.g., the server end 1820).

In 2001, a DICOM file stream may be established. It should be noted that as the server end 1820 includes the locally stored medical image data that is the same as the unparsed medical image data in the first processing stream, the DICOM file stream of the medical image data may be established in advance to write the medical image data to the second processing stream.

In 2003, file meta information of the DICOM file stream may be parsed. It should be noted that as the DICOM file stream is no longer a network stream, the file meta information may no longer exist in the header data. That is, in some embodiments, the DICOM file stream may not record the file meta information, and the file meta information of the DICOM file stream may be default information that needs to be inferred according to the DICOM standard (e.g., DICOM 3.0 standard).

In 2005, the parsed file meta information and the unparsed medical image data in the DICOM file stream may be written to the second processing stream. It should be noted that the second processing stream may be the socket network stream that is sent externally.

In 2007, the second processing stream may be sent externally.

According to some embodiments of the present disclosure, there is no need to write all received data sets into the memory of the image file system, which avoids excessive consumption of the memory resource. At the same time, there is no need to write all received data sets into the local cache of the image file system, and then retrieve them from the local cache, which avoids the sharp increase of I/O operations that may reduce the system processing performance. In addition, the source of the medical image data written into the second processing stream may be selected according to whether the server end (e.g., the server end 1820) (which is as a forwarding transfer station) is stored with the medical image data to be forwarded, thereby improving the fault tolerance of data forwarding.

When the service type is the forwarding service, the data source of the unparsed medical image data may be the first processing stream or a local file stream. When the data source is the first processing stream, the unparsed medical image data may be obtained from the first processing stream. In such cases, the recorded data length of the medical image data in the parsed header data may be compared with the actual data length of the unparsed medical image data in the first processing stream. If the recorded data length and the actual data length are inconsistent, the unparsed medical image data may not be obtained from the first processing stream and a resend message may be fed back to the client end 1810, so that the client end 1810 may resend/retransmit the first processing stream. If the recorded data length and the actual data length are consistent, the unparsed medical image data may be obtained from the first processing stream, and the unparsed medical image data may be written to the second processing stream without passing the memory or the local cache. As the determination result of whether the actual data length and the recorded data length can be used to indicate whether the medical image data in the first processing stream is wrong, the determination process may avoid writing wrong medical image data to the second processing stream, thereby ensuring the data accuracy of the second processing stream in subsequent processes.

In some embodiments, the present disclosure may not limit the mode of how to process the second processing stream. For example, the second processing stream may be sent externally according to an instruction of the column storage database. The column storage database may include the C-Store. In addition, the storage service and the forwarding service may be performed concurrently (e.g., in a parallel fashion) between different client ends and server ends. According to some embodiments of the present disclosure, the concurrent amount of the C-Store instructions may be continuously increased, thereby the DICOM files may be transmitted quickly under the DICOM protocol. At the same time, the entire transmission system 100 composed of client ends and server ends may achieve higher throughput.

In some embodiments, as the C-Store database is adapted to store the DICOM files, and the data length of the C-Store database column is fixed, there is no need to consider the memory alignment in the database implementation, which avoids or reduces the situation of data crossing the boundary which may cause two memory accesses are required for one data process, so that the data element may be encoded into the most effective form without being limited by the size of the DICOM file.

It should be understood that although the operations from FIG. 17 to FIG. 20 are displayed in order according to the arrow's instructions, these operations are not necessarily performed in such order. Unless specified in the present disclosure, the implementations of the operations do not have strict order restrictions and may be performed in other orders. In some embodiments, one or more of the operations may include a plurality of sub-operations or steps, these sub-operations or steps may not necessarily be performed at the same time. For example, the plurality of sub-operations or steps may be performed at different times. As another example, the plurality of sub-operations or steps may be performed in turn with other operations or the sub-operations or steps of other operations instead of being performed in order.

FIG. 21 is a schematic diagram illustrating an exemplary process for DICOM file transmission according to some embodiments of the present disclosure. In some embodiments, the process 2100 may be implemented as a set of instructions (e.g., an application) stored in a storage device (e.g., the storage device 1230, the storage device 220, and/or the storage 390). The processing device 1400c (e.g., the processor 210, the CPU 340, and/or one or more modules illustrated in FIG. 14C) may execute the set of instructions, and when executing the instructions, the processing device 1400c may be configured to perform the process 2100. The operations of the illustrated process presented below are intended to be illustrative. In some embodiments, the process 2100 may be accomplished with one or more additional operations not described and/or without one or more of the operations discussed. Additionally, the order of the operations of process 2100 illustrated in FIG. 21 and described below is not intended to be limiting. In some embodiments, the process 2100 may be implemented by a server end such as an image file system (e.g., the PACS and the C-Store SCU thereof). The processing device 1400c may be a part of the server end. Alternatively, the process 2100 may be implemented by a client end (e.g., the terminal 1240).

In 2101, the processing device 1400c (e.g., the reading module 1431) may obtain initial pixel label of an initial DICOM file.

In some embodiments, the initial DICOM file refers to a DICOM file of transmitted medical images. The amount of pixel data of the transmitted medical images may be relatively large, and may generally account for more than 97% of the size of the initial DICOM file. Generally speaking, the DICOM file may show a table containing a variety of tags (labels) after being parsed. Each line of the table contains an ID, a description, a type, a data length, and a label value (tag value) of a tag. For example, for a tag in a specific line, the ID of the tag may be (0010, 0010), the description of the tag may be the patient's name, the type of the tag may be PN, the data length of the tag may be 10, and the tag value of the tag may be Wu XX. Other tags, such as the patient's height, the patient's weight, and other information may also be recorded in the table of the DICOM file. For example, the DICOM file may include a tag whose ID is (7FE0,0010). The tag value of the tag (7FE0,0010) may be the pixel data of the transmitted medical image. As the pixel data accounts for more than 97% of the size of the DICOM file, the present disclosure may divide tag values of the DICOM file into pixel label values and non-pixel label values. In some embodiments, the content of the pixel label value (i.e., initial pixel data) may exist in the initial DICOM file in the form of an attachment, that is, in the form of a file including the initial pixel data. The file including the initial pixel data refers to a pixel information file of the transmitted medical image. In some embodiments, the preset transmission protocol may include a DICOM protocol (also referred to as a DICOM transmission protocol). Under the protocol, a connection pool may be established to transmit the plurality of DICOM sub-files in a parallel fashion to a target receiving end (e.g., a server end such as the C-Store SCP of the PACS, the server end 1820, or a client end such as the terminal 1240, etc.).

In some embodiments, the processing device 1400c may read the initial pixel label value (e.g., the tag value of the tag (7FE0,0010)) in the initial DICOM file to obtain the initial pixel data, so as to divide the initial pixel data into the plurality of pixel groups, so as to facilitate the subsequent transmission of the divided initial DICOM file.

In 2103, the processing device 1400c (e.g., the division module 1433) may divide (or segment) the initial pixel data into a plurality of pixel groups.

In some embodiments, the processing device 1400c may divide the initial pixel data equally or unequally into the plurality of pixel groups. For example, the initial pixel data may be equally divided into, e.g., 10, 15, or 20 pixel groups. As another example, the initial pixel data may be unequally divided. For instance, the first or last pixel group of the plurality of pixel groups may have different data lengths from other pixel groups of the plurality of pixel groups. In some embodiments, each of the plurality of pixel groups may be recorded with a sequence number that indicates a division (or segmentation) order of the pixel group in the initial pixel data.

In 2105 the processing device 1400c (e.g., the first generation module 1435) may generate a plurality of DICOM sub-files based on the plurality of pixel groups and the initial DICOM file.

In some embodiments, the processing device 1400c may generate the plurality of DICOM sub-files based on the plurality of pixel groups and the initial DICOM file according to operations of process 2200 as illustrated in FIG. 22. The process 2200 may include operations 2201 and 2203.

In 2201, the processing device 1400c may designate each of the plurality of pixel groups as first pixel data.

In 2203, the processing device 1400c may generate the plurality of DICOM sub-files by using, according to a transmission protocol (e.g., the DCIOM protocol), metadata of the initial DICOM file and a plurality of first pixel data corresponding to the plurality of pixel groups. For example, the processing device 1400c may read the non-pixel label value in the initial DICOM file to obtain the metadata of the initial DICOM file. For each of the plurality of pixel groups, the processing device 1400c may generate a DICOM sub-file by combining, according to the transmission protocol, the metadata of the initial DICOM file and the pixel group.

In some embodiments, each of the plurality of the DICOM sub-files may include the divided initial pixel data (e.g., the first pixel data). As used herein, the first pixel data refers to pixel data of a DICOM sub-file. The processing device 1400c may designate each of the plurality of pixel groups as one of a plurality of first pixel data of the plurality of DICOM sub-files. The processing device 1400c may generate each of the plurality of DICOM sub-files by combining, according to the transmission protocol, one of the plurality of first pixel data and the metadata of the initial DICOM file, so that each DICOM sub-file may be a file with relatively complete label information (e.g., complete basis tags) to satisfy the DICOM communication protocol.

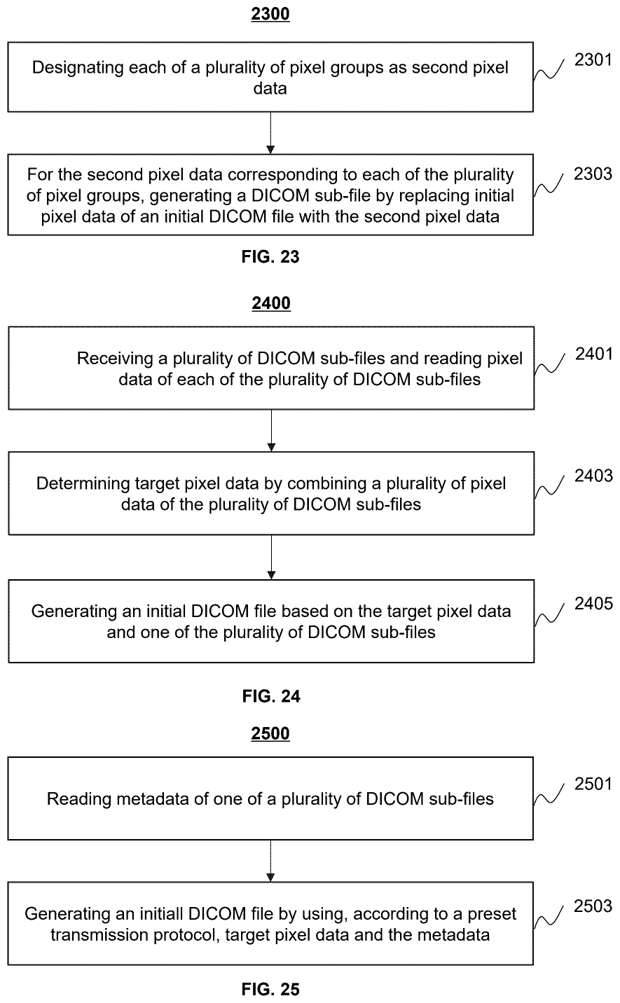

In some embodiments, the processing device 1400c may generate the plurality of DICOM sub-files based on the plurality of pixel groups and the initial DICOM file according to operations of process 2300 as illustrated in FIG. 23. The process 2300 may include operations 2301 and 2303.

In 2301, the processing device 1400c may designate each of the plurality of pixel groups as second pixel data.

In 2303, for the second pixel data corresponding to each of the plurality of pixel groups, the processing device 1400c may generate a DICOM sub-file of the plurality of DICOM sub-files by replacing the initial pixel data of the initial DICOM file with the second pixel data.

In some embodiments, the second pixel data corresponding to each of the plurality of pixel groups may be added independently to the initial DICOM file in the form of an attachment, that is, the second pixel data corresponding to each of the plurality of pixel groups may replace the initial pixel data in the initial DICOM file, so as to obtain different DICOM sub-files. Each DICOM sub-file may contain the metadata and their corresponding second pixel data, such that each DICOM sub-file has relatively complete label information (e.g., complete basic tags) and satisfies the transmission protocol.

It should be understood that the first pixel data and the second pixel data are the same. The present disclosure uses the first and second to distinguish different embodiments. In addition, it should be noted that, in the existing technology, the DICOM file after simple physical division may not support the DICOM transmission protocol, and may not be used normally to obtain the label information (e.g., the header data); while in the present disclosure, each of the DICOM sub-files generated after division may have relatively complete label information and supports the DICOM transmission protocol. The receiving end may normally obtain label information of each DICOM sub-file, which helps to complete the DICOM file transmission, storage, and display of the medical images.

In 2107, the processing device 1400c (e.g., the sending module 1437) may send/transmit the plurality of DICOM sub-files according to a preset transmission protocol (e.g., the DICOM protocol).

In some embodiments, each of the plurality of DICOM sub-file may be sent/or transmitted via a data stream (e.g., a network stream such as the first data stream as described in FIG. 15 or the first processing stream as described in FIG. 17) via a network (e.g., the network 1250) to a server end (e.g., the processing device 1400a, 1400b, or 1400d, the C-Store SCP, or the server end 1820). That is, the plurality of DICOM sub-files may be transmitted in a parallel fashion. During the transmission of the plurality of DICOM files, one or more of the plurality of data streams corresponding to the plurality of DICOM files may be interrupted (e.g., which may be caused by a network factor, a bandwidth factor, a human factor, etc.). The processing device 1400c may record the one or more of the plurality of data streams and re-transmit the one or more of the plurality of data streams. That is, data streams that have not been recorded may be not re-transmitted. In some embodiments, as described in FIGS. 5 and 7, a DICOM sub-file may be transmitted by multiple segments of a data stream. When the data stream is interrupted during transmission, the processing device 1400c may record an interruption position (e.g., a specific segment of the data stream) and re-transmit segments of the data stream after the interruption position. That is, segments of the data stream before the interrupt position may not re-transmit.

FIG. 24 is a schematic diagram illustrating an exemplary process for DICOM file storage according to some embodiments of the present disclosure. In some embodiments, the process 2400 may be implemented as a set of instructions (e.g., an application) stored in a storage device (e.g., the storage device 1230, the storage device 220, and/or the storage 390). The processing device 1400d (e.g., the processor 210, the CPU 340, and/or one or more modules illustrated in FIG. 14D) may execute the set of instructions, and when executing the instructions, the processing device 1400c may be configured to perform the process 2400. The operations of the illustrated process presented below are intended to be illustrative. In some embodiments, the process 2400 may be accomplished with one or more additional operations not described and/or without one or more of the operations discussed. Additionally, the order of the operations of process 2400 illustrated in FIG. 24 and described below is not intended to be limiting. In some embodiments, the process 2400 may be implemented by a server end such as the image file system (e.g., a local file system such as the PACS or the C-Store SCP thereof). The processing device 1400d may be a part of the server end. Alternatively, operations of the process 2400 may be implemented by the processing device 120a or 120b.

In 2401, the processing device 1400d (e.g., the receiving module 1441) may receive a plurality of DICOM sub-files (e.g., from a client end such as the terminal 1240 or the client end 1810) and read pixel data (e.g., first pixel data/second pixel data) of each of the plurality of DICOM sub-files. The pixel data of each of the plurality of DICOM sub-files may carry a corresponding sequence number that indicates an initial division order of the pixel data.

In 2403, the processing device 1400d (e.g., the combination module 1443) may determine target pixel data by combining/merging a plurality of pixel data of the plurality of DICOM sub-files. For example, the plurality of pixel data may be combined or merged according to their corresponding sequence numbers.

In 2405, the processing device 1400d (e.g., the second generation module 1445) may generate an initial DICOM file based on the target pixel data and one of the plurality of DICOM sub-files. The initial DICOM file may be used to generate the plurality of DICOM sub-files.

In some embodiments, when the plurality of DICOM sub-files (e.g., 10 DICOM sub-files) are received, pixel data of each DICOM sub-file may be read to obtain 10 pixel data. The 10 pixel data may be combined according to sequence numbers corresponding to the 10 pixel data to obtain the target pixel data. The initial DICOM file corresponding to the 10 DICOM sub-files may be generated based on the target pixel data and one of the 10 DICOM sub-files. In some embodiments, a count (or number) of the plurality of DICOM sub-files received may be determined according to the actual count (or number) of divisions.

In some embodiments, the processing device 1400d may generate the initial DICOM file based on the target pixel data and one of the plurality of DICOM sub-files according to operations of process 2500 as illustrated in FIG. 25. The process 21500 may include operations 2501 and 2503.

In 2501, the processing device 1400b may read metadata (e.g., all the non-pixel label values) in one of the plurality of DICOM sub-file.

In 2503, the processing device 1400b may generate the initial DICOM file by using, according to the preset transmission protocol, target pixel data and the metadata.

It should be noted that the target pixel data refers to the complete initial pixel data of the initial DICOM file that is determined after the combination. After receiving all the DICOM sub-files, the processing device 1400b may read/obtain the metadata of any one of the DICOM sub-files. Then, the target pixel data and the metadata in any one of the DICOM sub-files may be combined according to the preset transmission protocol (e.g., the DICOM protocol) to generate the complete initial DICOM file, thereby the transmitted medical images can be completely displayed.

In some embodiments, the processing device 1400d may generate the initial DICOM file by designating the target pixel data as the pixel data of any one of the DICOM sub-files. For example, the complete initial DICOM file may be generated by replacing the pixel data of any one of the DICOM files with the target pixel data).

Different from the existing technology, according to some embodiments of the present disclosure, the initial pixel data (e.g., the tag value of the tag ID (7FE0,0010)) in the initial DICOM file may be read and obtained and the initial pixel data may be divided into the plurality of pixel groups, so as to facilitate the subsequent transmission of the divided initial DICOM file. According to the plurality of pixel groups and the initial DICOM file, the plurality of DICOM sub-files may be generated, which ensures that each DICOM sub-file can have complete basic tags and information thereof to satisfy the transmission protocol (e.g., the DICOM protocol). By sending the plurality of DICOM sub-files through the preset transmission protocol, the image file system may achieve successful transmission of the initial DICOM file by the transmission of the DICOM sub-files, which helps the target receiving end to display the transmitted medical images normally. It should be noted that compared with the initial DICOM file, despite the different integrity of the pixel data, the header data/metadata of each DICOM sub-file may be completely consistent with that of the initial DICOM file, so as to support the DICOM protocol for transmission and storage.

In addition, the target receiving end may receive each of the DICOM sub-files and read (e.g., obtain) the pixel data of each of the DICOM sub-files. Then pixel data of each of the DICOM sub-files may be combined/merged to obtain the target pixel data. Then, the complete initial DICOM file may be generated quickly based on any one of the DICOM sub-files and the target pixel data, so as to smoothly store the initial DICOM file and/or normally display the transmitted medical image.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

What is claimed is:

1. A method for data masking, which is implemented on a computing device including at least one processor and at least one storage device, comprising:
obtaining at least one original file;
obtaining a masking template for the data in the at least one original file;
masking the data in the at least one original file based on the masking template, to generate at least one target file; and
storing the at least one target file.

2. The method of claim 1, wherein the obtaining at least one original file comprises:
obtaining a file search query from a user; and
obtaining the at least one original file based on the file search query.

3. The method of claim 1, wherein the obtaining a masking template for the data in the at least one original file comprises:
obtaining at least one masking mode for the data in the at least one original file;
obtaining at least one masking value corresponding to the at least one masking mode; and
obtaining the masking template based on the at least one masking mode and the at least one masking value.

4. The method of claim 3, wherein the data in the at least one original file includes a plurality of tags configured to describe identification information related to the at least one original file, the masking template includes the at least one masking mode for at least one tag of the plurality of tags of the at least one original file, and the masking the data in the at least one original file based on the masking template, to generate at least one target file comprises:
for each tag of the at least one tag of the plurality of tags, modifying at least part of a value of the tag based on a masking value corresponding to a corresponding masking mode for the tag; and
generating the at least one target file based on at least one modified value of the at least one tag of the plurality of tags.

5. The method of claim 4, wherein the method further includes:
obtaining a hierarchical relationship that is associated with data in the at least one original file by
obtaining a tag-based hierarchical relationship of the plurality of tags of the at least one original file, and
the storing the at least one target file includes:
storing the at least one target file based on the hierarchical relationship.

6. The method of claim 4, further comprising:
verifying the at least one masking value in the masking template.

7. The method of claim 6, wherein the verifying the at least one masking value in the masking template comprises:
for each masking value of the at least one masking value in the masking template,
obtaining a data type of a value of a tag; and
determining whether the masking value satisfies the data type of the tag; and
in response to determining that the masking value satisfies the data type of the tag, determining that the masking value as a verified masking value.

8. The method of claim 1, further comprising:
obtaining at least one processed target file by performing a format conversion operation on the at least one target file; and
exporting the at least one processed target file.

9. The method of claim 1, further comprising:
storing the at least one target file in a shared storage space.

10. The method of claim 1, wherein the at least one original file includes a digital imaging and communications in medicine (DICOM) file.

11. The method of claim 1, wherein the masking template includes a plurality of masking modes for the data in the at least one original file, and at least two masking modes of the plurality of masking modes are different.

12. A system for data masking, comprising:
at least one storage device including a set of instructions; and
at least one processor configured to communicate with the at least one storage device, wherein when executing the set of instructions, the at least one processor is configured to direct the system to perform operations including:
obtaining at least one original file;
obtaining a masking template for the data in the at least one original file;
masking the data in the at least one original file based on the masking template, to generate at least one target file; and
storing the at least one target file.

13. The system of claim 12, wherein the obtaining at least one original file comprises:
obtaining a file search query from a user; and
obtaining the at least one original file based on the file search query.

14. The system of claim 12, wherein the obtaining a masking template for the data in the at least one original file comprises:
obtaining at least one masking mode for the data in the at least one original file;
obtaining at least one masking value corresponding to the at least one masking mode; and
obtaining the masking template based on the at least one masking mode and the at least one masking value.

15. The system of claim 14, wherein the data in the at least one original file includes a plurality of tags configured to describe identification information related to the at least one original file, the masking template includes the at least one masking mode for at least one tag of the plurality of tags of the at least one original file, and the masking the data in the at least one original file based on the masking template, to generate at least one target file comprises:
for each tag of the at least one tag of the plurality of tags, modifying at least part of a value of the tag based on a masking value corresponding to a corresponding masking mode for the tag; and
generating the at least one target file based on at least one modified value of the at least one tag of the plurality of tags.

16. The system of claim 15, wherein the method further includes:
obtaining a hierarchical relationship that is associated with data in the at least one original file by
obtaining a tag-based hierarchical relationship of the plurality of tags of the at least one original file, and
the storing the at least one target file includes:
storing the at least one target file based on the hierarchical relationship.

17. The system of claim 15, wherein the at least one processor is configured to direct the system to perform operations including:
verifying the at least one masking value in the masking template.

18. The system of claim 17, wherein the verifying the at least one masking value in the masking template comprises:
for each masking value of the at least one masking value in the masking template,
obtaining a data type of a value of a tag; and
determining whether the masking value satisfies the data type of the tag; and
in response to determining that the masking value satisfies the data type of the tag, determining that the masking value as a verified masking value.

19. The system of claim 12, wherein the at least one processor is configured to direct the system to perform operations including:
obtaining at least one processed target file by performing a format conversion operation on the at least one target file; and
exporting the at least one processed target file.

20. A non-transitory computer readable medium, comprising executable instructions that, when executed by at least one processor, direct the at least one processor to perform a method for motion correction, the method comprising:
obtaining at least one original file;
obtaining a masking template for the data in the at least one original file;
masking the data in the at least one original file based on the masking template, to generate at least one target file; and
storing the at least one target file.
